(19) United States
(12) Patent Application Publication
(10) Pub. No.: US 2019/0378119 A1
(43) Pub. Date: Dec. 12, 2019

(54) WALLET DEVICE FOR CRYPTOCURRENCY AND METHOD OF SIGNATURE FOR THE USE THEREOF

(71) Applicant: Fressets Inc., Tokyo (JP)

(72) Inventors: Masahiko HYUGA, Tokyo (JP); Kento SAWADA, Tokyo (JP)

(73) Assignee: Fressets Inc., Tokyo (JP)

(21) Appl. No.: 16/321,999

(22) PCT Filed: Jun. 12, 2018
(86) PCT No.: PCT/IB2018/054233

§ 371 Date: Jan. 30, 2019

(51) Int. Cl. G06Q 20/36; G06Q 20/06; H04L 9/32

(52) U.S. Cl. CPC G06Q 20/3674; G06Q 20/3678; H04L 2209/38; H04L 9/3247; H04L 2209/56; G06Q 20/0655

(57) ABSTRACT

A wallet device comprising, a central control server device to accept a trading request data from external, a transaction manage device, a hot wallet server device, a cold wallet server device and a remote signature device, the transaction manager device comprising unit to create/output transaction data conforming to the bitcoin network in the internet, is located in-between the central server device creating internal format model transaction and other devices group of hot wallet server device, cold wallet server device and the remote signature device performing to sign multi-signatures, providing more secured wallet device for cryptocurrency.

### FIELD OF TECHNOLOGY

This disclosure relates generally to a wallet device for cryptocurrency based on public key cryptography, using a private key to create a public key, which is used for a trading transaction via a network and the disclosure further relates to a method of a signature for the use thereof.

### BACKGROUND

It has been 10 years since the blockchain based bitcoin technology, which uses public key cryptography, was published in 2008. In Japan, the official terminology is legally defined as, “virtual currency”, in Payment Services Act. This is because, the aspect of usability in the value exchange via internet network virtually in contrast to physical objects such as coin or bill are taken weighted consideration more important than the aspect of cryptograph technology. In the present invention virtual currency denotes a cryptocurrency of public key cryptography which uses a private key to create a public key to be processed in creating an address in a transaction in network, whereas the virtual currency could be traded in the market in business like exchange.

FIG. 15 illustrates a schematic view of one of typical cryptocurrency, bitcoin network 10. A bitcoin network 10 comprises a miner 11 which creates a blockchain, wherein the blockchain keeps all the transaction records therein, and nodes 12, wherein each node validates the transaction and transfers the transaction to the miner 11.

Upon the transaction is transferred to bitcoin network, the processes described below are to be initiated as follows. The node in bitcoin network validates the transaction received and the verified transaction is to be propagated to the rest of neighbor nodes. Thereafter, a miner verifies the transaction according to the bitcoin protocol, so cold “mining”, then the transaction is to be written to another novel “block” which is a minimum member unit of a ledger. The created block is to be added to the end of the existing line of block collections. Because the transaction ledger constitutes sequenced collection of the blocks, it is named as blockchain after its appearance. The copy of the updated part of the blockchain is to be transferred to the node and each node maintains the blockchain comprising all the record of blocks. As the ledger added another block later to the end of the existing blockchain, part of the transaction are transferred from an existing owner to another owner according to the protocol. As the proof of the bitcoin transfer, the proof information, which is called “signature”, is to be imbedded in the transaction thereof.

Further in detail, the transaction comprising a bitcoin currency record currency amount belonging to the exiting owner, bitcoin currency amount which is to be transferred to another owner, and signature for the information to prove the reality of value chain in digital representation virtually (Non paten technical reference 1).

Information encrypted by owners is stored in the transaction according to public key cryptography architecture and the transaction propagates via network. If a leak of the private key happened, it would make value transfer realized against the owner's will and it would be practically difficult to restore the stolen amount. Theoretically the traceability for trading system may provide a clue to the investigation, however, it costs immense and substantially difficult to perform. The reason for the leak of a private key can be divided broadly into two categories, one of them is an internal job within the owner organization for the private key, and another is a leak via external network intrusion. In fact one of typical case exists such as Mt. Gox and another is the Coincheck incident. In former case, there could be a problem that the management system can allow administrator by himself alone take virtual currency external at his own will, and the latter case shows us the risk of big virtual currency amount which is exposed via external network intrusion.

Under the control of an owner, bitcoin architecture defines Wallet device 13 for storing a private key (Non patent technical reference 2). In the bitcoin architecture reference, the primary stage before a transaction is broadcasting from a user to bitcoin network, a user signs the transaction to approve value transfer from a user to others by using a private key. The wallet device stores and manage the private key. Suppose that all the private keys incurred were managed offline, wherein the private key were to be operated by more than two of operators at each transaction requested so as to make security level higher, however it would not be practical to do so for rather high management cost.

In bitcoin architecture, so called “multi-signature” protocol is proposed that a transaction is to be signed for approve so as to realize higher secured trading, however, it is not defined in the protocol in detail for method nor means to use multiple private keys and further in the present architecture, the solution is not disclose in detail how multiple private keys are to be integrated in system.

### PRIOR ART TECHNICAL LITERATURES

Non patent technical reference 1: For examples, Andreas, “Mastering Bitcoin”, page 1 third paragraph, NTT Publication, 2016.
Non patent technical reference 2: For examples, Andreas, “Mastering Bitcoin”, page 92 first paragraph, NTT Publication, 2016.

### SUMMARY

The present invention solves the problem mentioned above and places the purpose of, the present invention to provide a wallet device higher secured against and/or an internal job and an external network intrusion.

The present invention provides a higher secured wallet device to achieve the purpose above mentioned, as described below.

A wallet device for public key cryptography comprising: a public key derived from a private key creating an address so as to be used in trading via network;
a central control server device including a receiving unit for a trading request data, a first data store structure for specifying the address to identify the public key for a signature, an unsigned transaction creation unit having a second data store structure to hold the unsigned transaction, and a communication unit for a first communication network to transmit the unsigned transaction;
a hot wallet server device including a third data store structure data in memory to store or to create a private key, a communication unit for a second communication network to receive a signature request/send a signature and a cryptocurrency signature unit for the signature request;
a remote signature device offline from Internet including a third data store structure data in memory to store/create a private key, a cryptocurrency signature unit and a data propagation unit configured to input the signature request, wherein the data propagation unit is further configured to be controlled by an operator to output the signature corresponding to the signature request accepted through the data propagation unit;
a cold wallet server device including a communication unit for the second communication network configured to transmit data in both directions for receiving the signature requests from a signature requester and for sending the signature, wherein the cold wallet server device further includes a data store in memory configured to store an identification key as a mark for identifying the signature to be signed by the remote signature device, wherein the cold wallet server device further includes a data propagation unit configured to transfer data for signing remotely in combination with the remote signature device; and
a transaction manager device including a communication unit for the first communication network for receiving the unsigned transaction from the central control server device, a communication unit for the second communication network for sending the signature request outbound and receiving the signature from the hot wallet server device and/or the cold wallet server device, a signature status management unit to hold the unsigned transaction until the signatures completely signed, a data transformer unit to transform the unsigned transaction to a cryptocurrency transaction to conform a cryptocurrency network, a communication unit for the third communication network for the cryptocurrency transaction output, and a fourth data store structure data in memory to specify the public key corresponding to the third data store structure, wherein the fourth data store structure is structured by the identification key to identify the signature associated as a mark.

According to the constituents described above, in-between a central control server device of the wallet in which a proto-model of a transaction is created and the hot wallet server device/cold wallet server device in which the signature is created, there provided the transaction manager, therefore front facing to external network central control server is segregated from the hot wallet server device/cold wallet server device having information of the private key. Therefore, the invention provides more secure wallet device.

In another aspect, for the wallet device of the present invention described in the paragraphs so far, further, each of the communication unit for the first communication network may further comprise a server authentication function. The communication unit for the first communication network, located in-between the transaction manager device and the central control server of the wallet device, the communication unit having a server authentication function provides the wallet device with higher security level.

In another aspect, for the wallet device of the present invention described in the paragraphs so far, the transaction manager device of the invention may further be connected to plurality of the hot wallet server devices. The server processing tasks may be distributed in plurality of multiplexing hot wallet servers, multiplexing the hot wallet server device to provide larger processing power of the wallet device in total, therefore a scalability could be obtained. In another aspect, multiplexing the hot wallet server devices having the same private key may provide availability in case any failure in one of the hot server devices. Another hot wallet server devices other than a failure device may continue the uncompleted task processing, therefore the wallet device of the invention may acquire sustainability.

In another aspect, for the wallet device of the present invention described in the paragraphs so far, the cold wallet server device of the invention may further comprise a connection unit to a portable data output unit as a data propagation unit and a connection unit to an operation display panel unit being capable of presenting input prompt for outputting the portable data for the signature request, wherein the portable data output unit connected to the cold wallet server device provides faster and more precise in operation, and the information necessary to sign by the offline signature device can be propagated faster and more precisely to a signature site, and operations by an operator enable to output the portable data more in safe for the signature request.

In another aspect, for the wallet device of the present invention described in the paragraphs so far, further, the remote signature device offline from internet may comprise a connection unit to the portable data read unit and a connection unit to an operation display panel unit being capable of presenting input prompt for reading the portable data for the signature request, wherein an operator's intervention may be mandatory to read the portable signature request data. For the wallet device of the present invention, provide the opportunity to record progress of processing in system logs with operators intervention. The present invention provide higher level of operator's internal controls may offer more secure and precise offline signing environment.

In another aspect, for the wallet device of the present invention described in the paragraphs so far, the remote signature device offline from internet may further comprise a connection unit to the portable data output unit and a connection unit to an operation display panel unit being capable of presenting input prompt for outputting the portable signature data signed with the private key by cryptocurrency signature unit, wherein for the wallet device of the present invention, the portable data output unit with the operator display panel equipped to output the portable signature data with the signed signature. For the wallet device of the invention, also provide the opportunity to record progress of processing in system logs with operators intervention. The present invention provide higher level of operator's internal controls may offer more secure and precise offline signing environment, as described in the previous paragraph.

In another aspect, for the wallet device of the present invention described in the paragraphs so far, the cold wallet server device may further comprise a connection to the portable data read unit and a operation display panel unit being capable of presenting input prompt for reading the portable data with the signed signature, wherein an operator's intervention may be mandatory to read the portable signature request data, and upon reading the signed portable data, the portable data can be transmitted from the cold wallet server device to the transaction manager device through the third communication network. For the wallet device of the invention, also provide the opportunity to record progress of processing in system logs with operators intervention. The present invention also provide much higher level of operator's internal controls may offer more secure and precise offline signing environment, in addition to the effect described in the previous paragraph

In another aspect, for the wallet device of the present invention described in the paragraphs so far, further, the portable data media may be printed sheet with OR code, wherein the wallet device of the present invention may propagate data more easily.

In another aspect, for the wallet device of the present invention described in the paragraphs so far, further, the transaction manager device is connected to plurality of the cold wallet server devices, wherein the wallet device of the present invention provide more redundant configuration and more capacity, improving the scalability and availability of the processing of the group of the cold wallet server devices.

In another aspect, for the wallet device of the present invention described in the paragraphs so far, further, the unsigned transaction may be multi-signature transaction to be signed by multiple private keys, wherein for the wallet device of the present invention, the private keys corresponding to the unsigned transaction are stored distributed in plurality of the hot wallet server devices. In such configurations, the present invention enables to sign with multi-signature over the multiple hot wallet server device, enforcing a hacker intrude into multiple hot wallet servers for exposing the private keys, therefore the invention provide more secure wallet device.

In another aspect, for the wallet device of the present invention described in the paragraphs so far, further, the unsigned transaction may be multi-signature transaction to be signed by multiple private keys, wherein for the wallet device of the present invention, the private keys corresponding to the unsigned transaction are stored distributed in plurality of the signature devices offline from internet. In such configurations, the present invention enables to sign with multi-signature over the multiple cold wallet server device, therefore enforcing a hacker intrude into multiple sites because the signature devices are located offline from internet, for exposing the private keys, therefore the invention provide more secure wallet device.

In another aspect, for the wallet device of the present invention described in the paragraphs so far, further, the unsigned transaction may be a multi-signature transaction to be signed by multiple private keys, wherein the private keys corresponding to the unsigned transaction are stored distributed in one or plurality of the hot wallet server devices and one or plurality of the cryptocurrency signature devices offline from internet. In such configurations, the present invention enables to sign with multi-signature over the multiple hot wallet server device and the multiple cold wallet server device, therefore enforcing a hacker intrude into both hot wallet servers/cold wallet servers for exposing the private keys, the invention provide more secure wallet device.

In another aspect, for the wallet device of the present invention described in the paragraphs so far, further, the transaction manager device may comprise an output unit so as to create broadcast request data to a broadcast server for the cryptocurrency network. In such configurations, the present invention, upon completion of the cryptocurrency signature, in continuous processing, the wallet device of the present invention can create broadcast request data, there may be no room of human intervention, therefore the system operational environment prevent from internal crime job, providing a more secure wallet device.

In another aspect, the wallet device of the present invention described in the paragraphs so far, further, may be comprising:
a broadcast request server device including:
a broadcast request creation unit receiving the cryptocurrency transaction through the third communication network and creating broadcast request data therefrom; and
an output unit transmitting the broadcast request data via the cryptocurrency network. In the configuration of the present invention described as above, because the wallet device of the present invention arranges a broadcast request server between the transaction manager device and Internet network, and another third communication network is provided for dedicate use to access internet network separating the second communication network. This provide segregation Internet from the signature device more surely, providing a more secure wallet device of the present invention.

In another aspect, for the wallet device of the present invention described in the paragraphs so far, further, the wallet device of the present invention may comprises:
one or plurality of nodes, wherein the node includes a connection unit to a cryptocurrency network via internet enabled to broadcast via the cryptocurrency network; and
a node manager device including:
   a communication unit for the third network to receive the cryptocurrency transaction from the transaction manager device;
   one or plurality of connections with the one or plurality of nodes;
   a broadcast unit to prepare a broadcast data to transmit the cryptocurrency transaction via the node device. In a bitcoin network, transaction validations are generally to be performed using a consensus by majority of the network participants. Accordingly there could happen an incident when a broadcast requester is to be surrounded locally by nodes of intruders in local. In the configuration of the present invention described as above, because the wallet device of the present invention introduces at least one of own secure nodes, excluding such malice, providing a more secure wallet device.

In another aspect, for the wallet device of the present invention described in the paragraphs so far, further, the node manager device of the wallet device in the present invention may further comprise:

a receive unit receiving blockchain or unsigned transactions to be recorded in blockchain; and
a compare unit comparing among the blockchain and/or the unsigned transactions to be recorded in blockchain,
wherein the validation criteria in the compare unit for the blockchain and the unsigned transactions is whether matching party is majority or not. In such configurations, the wallet device of the present invention in this paragraph, introduces a function unit to mitigate the influence of such spoofing malice pretending one of normal nodes a broadcast requester is facing. The intruding malicious neighbor node to the wallet device may provide blockchain with spoofing malice, even if the a bitcoin network validates blocks by majority consensus method of proof of work. In the configuration of the present invention described as above, intruding nodes also may locally surround and occupy more than the half of the external boundary to cryptocurrency network, therefore the present invention provides a more secure wallet device.

In another aspect, for the wallet device of the present invention described in the paragraphs so far, further, one or plurality of the hot wallet server device of the wallet device in the present invention may locate in remote. In such configurations, for the wallet device of the present invention in this paragraph, both internally and externally, it is not obvious which servers located in remote shall be intruded, therefore the present invention provides a more secure wallet device. Or such configurations with multi-signature scheme, arranging one of the keys of multi-signature in the hot wallet server device in remote, an intruder is enforced to be systematic group of malice over the network. Therefore, more secured the wallet device is provided, effective against the internal malice jobs. Or such configurations with arranging the same key in remote redundantly, provides the wallet device effective against disasters to improve availability, providing much more secure wallet device.

In another aspect, for the wallet device of the present invention described in the paragraphs so far, further, one or plurality of the cold wallet server device of the wallet device in the present invention may locate in remote. In such configurations, for the wallet device of the present invention in this paragraph, both internally and externally, it is not obvious which servers located in remote shall be intruded, therefore the present invention provides a more secure wallet device. Or such configurations with multi-signature scheme, arranging one of the keys of multi-signature in the cold wallet server device in remote, an intruder is enforced to be systematic group of malice over the network. Therefore, more secured the wallet device is provided, effective against the internal malice jobs. Or such configurations with arranging the same key in remote redundantly, provides the wallet device effective against disasters to improve availability, providing much more secure wallet device.

In another aspect, for the wallet device of the present invention described in the paragraphs so far, the wallet device in the present invention may further comprise a operation panel display unit being capable of presenting input prompt for requesting the signature to responsible operators to be signed to the unsigned transaction conformed to specified condition, wherein the operation panel display unit is connected to the hot wallet server device via an operation display server device. In such configurations, the wallet device of the present invention in this paragraph, even the hot wallet server device can be introduce operator interventions to provide more secured wallet.

In another aspect, for the wallet device of the present invention described in the paragraphs so far, further, the operation panel display unit in the present invention may be further configured to display the prompt for signing for the unsigned transaction of total amount of payment to be approved more than a specified threshold value. In such configurations, for the wallet device of the present invention in this paragraph, the transaction of high cryptocurrency amount can be easily recognized and be focused and visible to operators, providing more secure wallet device.

In another aspect, for the wallet device of the present invention described in the paragraphs so far, further, the plurality of the hot wallet server devices the hot wallet server devices in the present invention may be configured to further includes a master data input unit for inputting from externally at least part of data elements of the third data store structure to store/create a private key, enabling at least part of data for storing/creating private keys in a partial group of the plurality of hot wallet server devices, wherein the transaction manager device having an output unit enabling to send the signature request to any hot wallet server devices in the group. In such configurations, the wallet device of the present invention in this paragraph, the location of the private key information is unobvious for internal jobs and also unobvious for intruder from external, and providing the flexibility of the operation usage. Therefore, security level of the wallet device in the present invention can be improved as well as flexibilities in disaster recover can also be provided. The improve of such availability contributes to provide more secured wallet device.

In another aspect, for the wallet device of the present invention described in the paragraphs so far, further, the first, the second and the third data store structure for storing or creating private keys of the wallet device in the present invention, include:
the key sequence number for deterministic generation feature of the wallet device; and
a series of data sufficient to create/recreate the private key. In such configurations, the wallet device of the present invention in this paragraph, eliminate needs to store the private keys, preventing the risk of the private keys directly stolen to externally, nor the risk of exposed externally, providing more secure wallet device. The present invention described in this paragraph is further effective to internal malice jobs, providing more secure wallet device

In another aspect, for the wallet device of the present invention described in the paragraphs so far, further, the first, the second and the fourth data store structure/structured data further include a master common key feature/a master common key data to create the signature request for the unsigned transaction, a master common key for the internal use in the cryptocurrency signature device to identify the sufficient private keys to sign the signature request for the unsigned transaction. In such configurations, for the wallet device of the present invention in this paragraph, the common key provides key chain with serial marks with no meaning stored in the wallet device, separating the data structure enable to be arranged distributed in the wallet device, providing more secure wallet device.

In another aspect, for the wallet device of the present invention described in the paragraphs so far, further, data comprising the common key and one or more seeds corresponding to the common key may be aggregated as one group and one or more set of the data group are stored for master data in the transaction manager device. A deterministic wallet constitute a group of provide keys/public keys combined by seeds of the deterministic wallet. In such configurations, for the wallet device of the present invention in this paragraph, enables data associated with deterministic wallet and the master common key are managed integrated in the wallet device among distributed servers appropriately, making possible priority management throughout the wallet device, for examples, based on the materiality. The data stored in transaction manager device provide more sure operation, especially for the multi-signature to achieve more secure wallet device.

In another aspect, for the wallet device of the present invention described in the paragraphs so far, further, each of the device is arranged in each virtual server device, respectively. In such an arrangement present invention provide economic benefit compared to an individual physical server configuration and provide higher level of the separation for the functions, providing more secure wallet device compared to the case in all the operation functionality being configured on one operating system.

In another aspect, for the wallet device of the present invention described in the paragraphs so far, further, part of the hot wallet server device may be arranged in a virtual server device provided in one or more cloud computing service server devices. In such configurations, for the wallet device of the present invention in this paragraph, cloud computing services provide part of the hot wallet server device managed by external system and organization may make intruders difficult to get private keys in cloud computing services, providing more secure wallet device. The offering by third party cloud computing services for variety and sophisticated network authentication no one would be possibly intrude between the cloud computing service server device and the hot wallet server device of the wallet device in the invention.

In another aspect, a method for signing signature for the private key for a cryptocurrency signature wallet device of claim 24 equipped with an operating system to control a hardware having CPU and memory configured with a software installed in the operating system, including an address data configured,

the method comprises a first stage including:
accepting data items by an API (API denoting Application Program Interface) received from a user system through a gateway communication; and
creating an unsigned transaction using the accepted data items in a software configured in an operating system on a central control server device,
wherein the cryptocurrency signature wallet device is configured as a deterministic wallet for trading, the method including to prepare the addresses created by using the public key and private key,
wherein the unsigned transaction including a specified data store structure including:
   one or plurality of seed data fields having used in creating multi-signature addresses in creating the deterministic wallet;
   a master common key field associated with the one or plurality of seed data;
   key sequence number data fields representing the sequence of the address creation; and
   signature data fields for storing the signatures,
wherein the central control server device having a communication unit for a first network to a transaction manager device,
wherein the first stage of the method further comprising transmitting the unsigned transaction from the central control server device to the transaction manager device through the communication unit for the first communication network between the central control server device and the transaction manager device,
   the method further comprising another sequenced second stage including
upon receiving the unsigned transaction in the transaction manager device through the communication unit for the first communication network by a software installed in the operating system on the transaction manager device, storing the unsigned transaction in a transaction pool in memory, the method further comprising another sequenced third stage including
for the software in the operating system on the transaction manager device entering status of wait for notification from another device being ready for a signature request,
   the method further comprising another fourth stage in parallel
for a software installed on an operating system on a hot wallet server device/a cold wallet server device to send a notification for signature request wait attached with the master common key through a communication unit for the second communication network to the transaction manager device,
   the method further comprising another sequenced fifth stage including:
upon receiving the notification, for a software installed on an operating system in the transaction manager device to search for unsigned transactions with the master common key matching in the transaction pool of unsigned transactions; and
sending one of the selected unsigned transaction for the signature request to the originator of the notification such as hot wallet sever devices or cold wallet server devices through the communication unit for the second network,
   the method further comprising another sequenced sixth stage including:
for a software installed on an operating system in the hot wallet server device to receive the signature request through a communication unit for the second communication network; and
   for the software installed on an operating system in a hot wallet server device to sign the signature request using the private key corresponding to the master common key; and
sending back the signature to the transaction manager device through the second communication network,
   the method further comprising another seventh stage in parallel to the sixth stage including:
upon receiving the signature request through a communication unit for the second communication network, for a software installed on an operating system in a cold wallet server device to output portable data through a data propagation unit for a signature device to sign the signature in remote;
for a software installed on an operating system in the signature device to read the portable data through a data propagation unit;
for a software installed on an operating system in the signature device to sign a signature using the private key corresponding to the portable data to output a portable data through the data propagation unit; and
for a software installed on an operating system in the cold wallet server device to transfer the signature through the second communication network,
   the method further comprising another sequenced eighth stage including:
upon receiving the signature through the communication unit for the second communication network, for a software installed on an operating system in the transaction manager device to write the signature in a signature field in the unsigned transaction;
summing up a number of signatures written in the signature fields to compare for validation to a specified criteria on sufficient number of multi-signatures to complete signing the unsigned transaction;
upon success in the validation, the signed transaction is to be transformed into the cryptocurrency transaction; and
upon failure in the validation, for the software on the operating system in the transaction manager device to return system flow control to the third stage to loop.

In another aspect, for the method for signing signature for the private key for a cryptocurrency signature wallet device of the present invention described in the paragraphs so far, further, the stage 3 of the method may be further comprising a communication protocol by polling from the hot wallet server device or the cold wallet server device. In such constitutions, the method for signing signature for the private key for a cryptocurrency signature wallet device of the present invention in the paragraph, provides much more surely maintain communication sessions and requires no other protocol controlling the signing operation for any number of hold/cold wallet server devices, resulting in rather simple flow control management easy to monitor exceptional events, providing more secure method for method for signing signature for the private key for a cryptocurrency signature wallet device.

In another aspect, a wallet device for public key cryptography comprising an operating software installed on the operating system to control a hardware equipped with CPU and memory therein, the software having configured a public key derived from a private key and the software having configured an address derived from the public key, wherein the software comprising:
a API (API denoting Application Program Interface, hereafter) input module for accepting trading request data through API;
a central control module reading first data store structure data specifying the address to identify the public key for a signature, and creating an unsigned transaction having the second data store structure for holding the unsigned transaction;
a hot wallet module signing a cryptocurrency signature having the third data store structure data in memory to store the private key or to create the private key;
a cold wallet server module for offline signature having an identification key stored in memory to identify the signature associated as a mark;
a transaction manager module controlling a signing flow having been enabled to store the fourth data store structure including the third data store structure for holding or creating the private key structured by a master common key shared among multiple modules to identify the private key and
including the second data structure for holding the unsigned transaction;
an external communication module communicating for external interface from API input module;
a first communication module receiving/transmitting unsigned transactions and signed transactions between the transaction manager module and central control module;
a second communication module receiving/transmitting unsigned transactions and signed transactions between the transaction manager module and the hot wallet module or between the transaction manager module and the cold wallet server module;
a data propagation module receiving portable signature request data/transmitting portable signature data from/to the signature device for offline signatures.
data transform module transforming the signed transaction into the cryptocurrency transaction; and
output module creating/outputting broadcast request data for the cryptocurrency by accepting all the signature completed by the transaction manager module,

wherein the wallet device further comprising:
a cryptocurrency signature device further equipped with:
   having configured the third data store structure to store the private key or to create the private key;
   having the data propagation unit configured; and
   having cryptocurrency signature unit configured for the signature request input through the data propagation unit. In such configurations, for the wallet device of the present invention in this paragraph, the multiple functions presented in the server devices described above are reorganized as discrete function modules in a software makes it possible to separate functions by module boundary and modules to be able to be re-arranged over various server configurations, providing easy and flexible functional module/server configuration, still communication modules may be arranged between functional modules, providing more secure wallet device compared to all functional module in one module.

In another aspect, for the wallet device of the present invention described in the paragraphs so far, further the central control module and the transaction manager module may be operated on the same operating system. In such configurations, according to the present invention in this paragraph, requires the least system resources to suit for entry level implementation, still more secure wallet device may be provided by separation of functional modules.

In another aspect, for the wallet device of the present invention so far, one or plurality of the hot wallet server module may be further operated on the same operating system as the transaction manager module. According to the present invention in this paragraph, the central control module may be operated in another operating system separated from the first operating system being provided with the central control module, in such configuration, as the private key stored in the same server with the hot wallet module, the private key is separated from the central control module, therefor it is so difficult for the central control module, even if being intruded here, to make use of the private key, providing more secure wallet device.

In another aspect, for the wallet device of the present invention described in the paragraphs so far, further the hot wallet server module may further be operated on another one or plurality of operating system except for the operating system operating on the transaction manager module. In such configurations, according to the present invention in this paragraph, the hot wallet module is operated in another operating system, separated from the operating system the central control module and transaction manager module. Therefore, it is more difficult for the central control module and transaction manager module, even if being intruded, to make use of the private key, providing more secure wallet device.

In another aspect, for the wallet device of the present invention described in the paragraphs so far, further the cryptocurrency is a virtual currency. It is required for the virtual currency to conform higher level of security in business compared to other cryptocurrency in general, such configurations, according to the present invention provides more secure wallet device which further suites much more to the virtual currency.

In another aspect, for the wallet device of the present invention described in the paragraphs so far, further the cryptocurrency is bitcoin. As the information of bitcoin is disclosed, the requirement of security level is high. According to the present invention, person skilled in the art can configure more secure wallet device, which is especially preferable for bitcoin.

In another aspect, for the method for signing signature for the private key for a cryptocurrency signature wallet device of the present invention described in the paragraphs so far, further the cryptocurrency may be a virtual currency. It is required for the virtual currency to conform higher level of security in business compared to other cryptocurrency in general, further constitution for the methods of the present invention provides more secure method for signing signature for the private key for a cryptocurrency signature wallet device which further suites much more to the virtual currency.

In another aspect, for the method for signing signature for the private key for a cryptocurrency signature wallet device of the present invention described in the paragraphs so far, further, the cryptocurrency may be bitcoin, As the information of bitcoin is disclosed, the requirement of security level is high. As the information of bitcoin is disclosed, the requirement of security level is high. According to the present invention, person skilled in the art can constitute more secure method for signing signature for the private key for a cryptocurrency signature wallet device, which is especially preferable for bitcoin.

In another aspect, for the wallet device of the present invention described in the paragraphs so far, further, the cryptocurrency is a meta coin or an alt coin, including partially adding attributes and/or modifying attributes to bitcoin. The meta coin and the alt coin make use of on blockchain technology, person skilled in the art can configure the wallet device of the present invention described in the paragraphs so far, with the meta coin or the alt coin providing more secure wallet, which is especially preferable for the wallet device of the present invention described in the paragraphs so far.

In another aspect, for the method for signing signature for the private key for a cryptocurrency signature wallet device of the present invention described in the paragraphs so far, further, the cryptocurrency is a meta coin or an alt coin,

including partially adding attributes and/or modifying attributes to bitcoin. The meta coin and the alt coin make use of on blockchain technology, person skilled in the art can constitute the method for signing signature for the private key for a cryptocurrency signature wallet device of the present invention described in the paragraphs so far, with the meta coin or the alt coin, providing more secure method for signing signature for the private key for a cryptocurrency signature wallet device, which is especially preferable for the method for signing signature for the private key for a cryptocurrency signature wallet device described in the paragraphs so far.

In another aspect, for the wallet device of the present invention described in the paragraphs so far, further, the transaction request data can be derived by the protocol between a requester server program and API (API denoting, Application Program Interface), including:
1) master common key to specify one or plurality of payer;
2) one or plurality of destination address (addresses).
3) payment amount
4) transaction fee cover code to determine whether the processing fee for cryptocurrency network is to be paid by the address identified by the address specifying payer cryptocurrency account in transaction input or payer address derived from the master common key or the destination address. In such configurations, according to the present invention in this paragraph, the API data in internal use for the wallet device are to be converted from the individual data format depending on preference of each client, maximizing the common process by the common API, while customized processes with customized data are minimized, providing to build common trouble database for installation so as to share the solution to the trouble, improving security for the wallet device.

In another aspect, the wallet device of the present invention described in the paragraphs so far, further, may have the second data store structure and the structure data thereof to hold the unsigned transaction, for the use of transaction input data items, including one or plurality pairs of data items 1) and 2) listed below, conformed to bitcoin standard transaction in the bitcoin architecture to identify a Unspent Transaction Output (UTXO, denoting Unspent Transaction Output) and the previous transaction, the second data store structure including:
1) prev hash; and
2) prev hash output index,
   the second data store structure further including one or plurality of a pair of data items 3) and 4) listed below, conformed to bitcoin standard transaction output data items in bitcoin architecture, second data store structure further including:
3) destination address; and
4) amount of the cryptocurrency,
   the second data store structure further including eTX (denoting extended transaction) input data items per transaction input, the second data store structure further including:
5) a master common key field for storing the master common key to identify the public key corresponding to the first data store structure data; and
6) key sequence number data having been used in a deterministic wallet creation,
   the extended-transaction data fields within the second data store structure further including:
7) signature fields to store the signatures, the extended-transaction data within the second data store structure further including:
8) transaction status code data field to store an identifier for waiting status for the signature or signed status validated, or transmitted status, respectively. In such configurations, according to the present invention in this paragraph, extended data items for use of unsigned transaction are defined as internal data store structure being included to transaction data, renamed as “extended transaction”, enables appropriate system data information distributed and segregated among server units, configured for private keys, providing more secure wallet device.

In another aspect, the wallet device of the present invention described in the paragraphs so far, further, may have the third data store structure and the structure data thereof to store the private key or to create the private key, comprising data items:
1) the private key seed field having been used in the deterministic wallet creation; and
2) the key sequence number data fields having been used in the deterministic wallet creation.
   In such configurations, according to the present invention in this paragraph, the deterministic wallet the private keys may be created at signing dynamically in the wallet device, providing more secure wallet device.

In another aspect, the wallet device of the present invention described in the paragraphs so far, further, may have the fourth data store structure and the structure data thereof to specify the private key, comprising data items:
1) the master common key fields to identify the private key in the third data store structure data, and
each master common key holding:
2) one or plurality of the seed field for the public key having been used in creating the deterministic wallet, corresponding to one or plurality of the multi-signature;
3) the key sequence number data fields representing the sequence of the address creation,
   In such configurations, according to the present invention in this paragraph, the public keys may be created at signing dynamically as well as the private keys, therefor the public keys being able to be managed integrated as the private keys, providing integrity between the public keys and the private keys to achieve higher security in the wallet device.

As described herein the wallet devices of the invention are more secure against the internal malice jobs and intrusion through external network, providing systems device with scalability, improving availability. therefore the wallet device of present invention, further provides much more secure wallet devices from the such security point of view.

### BRIEF DESCRIPTION OF THE DRAWINGS

FIG. 1 illustrates a high level conceptual block diagram for an embodiment of the present invention of a wallet device.

FIG. 2 illustrates a overall functional block diagram for an embodiment of the present invention of a wallet device.

FIG. 3 illustrates software functional block diagram for API module, configured in an embodiment of the present invention of a wallet device, schematically overlaid with a flowchart of the functional block relationship.

FIG. 4 illustrates software functional block diagram for central control module, configured in several embodiments of the present invention of Wallet device, schematically overlaid with a flowchart of the functional block relationship.

FIG. 5 illustrates software functional block diagram for transaction manager module, configured in several embodiments of the present invention of a wallet device, schematically overlaid with a flowchart of the functional block relationship including internal functional flowchart in the block.

FIG. 6 illustrates software functional block diagram for hot wallet server module and operation panel display, configured in several embodiments of the present invention of a wallet device, schematically overlaid with a flowchart of the functional block relationship including internal functional flowchart in the block.

FIG. 7 illustrates software functional block diagram for cold wallet server module, remote operation module and remote signature module, configured in several embodiments of the present invention of a wallet device, schematically overlaid with a flowchart of the functional block relationship including internal functional flowchart in the block.

FIG. 8 illustrates software functional block diagram for node manager module, configured in several embodiments of the present invention of Wallet device, schematically overlaid with a flowchart of the functional block relationship including internal functional flowchart in the block.

FIG. 9 illustrates functional block diagram for hardware, operating system and software, configured in another embodiment of the present invention of a wallet device, providing schematic view of block arrangement boundary.

FIG. 10 illustrates functional block diagram for hardware, operating system and software, configured in another alternative embodiment of the present invention of a wallet device, providing schematic view of block arrangement boundary.

FIG. 11 illustrates functional block diagram for hardware, operating system and software, configured in another alternative embodiment of the present invention of a wallet device, providing schematic view of block arrangement boundary.

FIG. 12 illustrates functional block diagram for hardware, operating system and software, configured in another alternative embodiment of the present invention of a wallet device, providing schematic view of block arrangement boundary.

FIG. 13 illustrates schematic overall architecture schematic view in several embodiments of the present invention of a wallet device, having multiple server arrangements for hot wallet server devices and cold wallet server devices.

FIG. 14 illustrates a method flow chart for signing used in several embodiments of the present invention of a wallet device.

FIG. 15 illustrates bitcoin network architecture schematic view for a prior typical art.

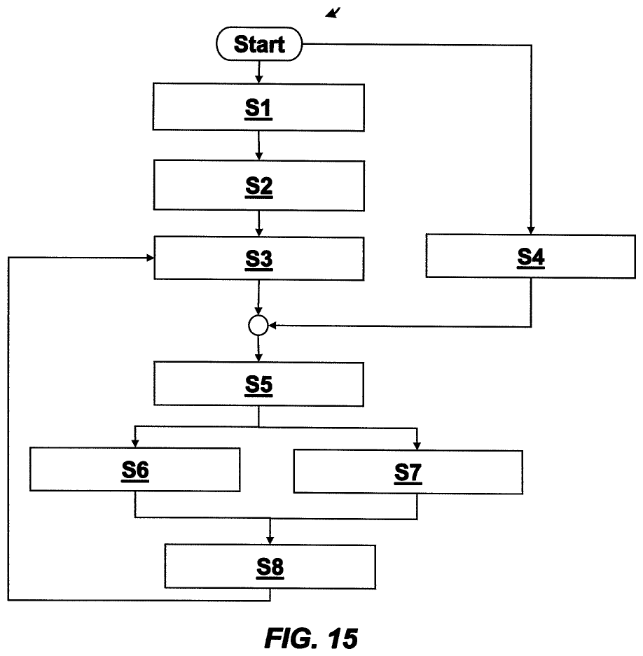

### DETAILED DESCRIPTION

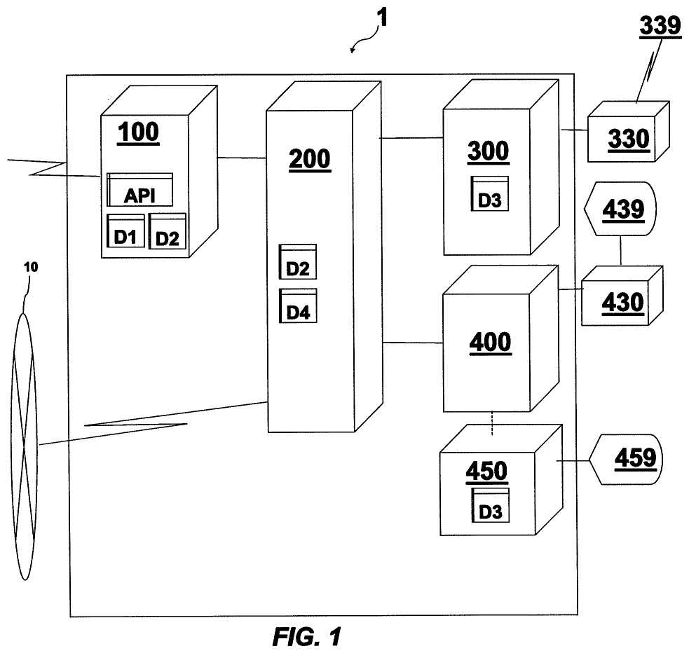

A embodiment of a wallet device 1 for the present invention is described as follows. FIG. 1 illustrates the wallet device 1 comprises a central control server device 100 accepting trading request data from external, a transaction manager device 200, a hot wallet server device 300, and a cold wallet server device 400 and a signature device 450, the transaction manager server device 200 having units creating and outputting data conforming to bitcoin network on the Internet to output.

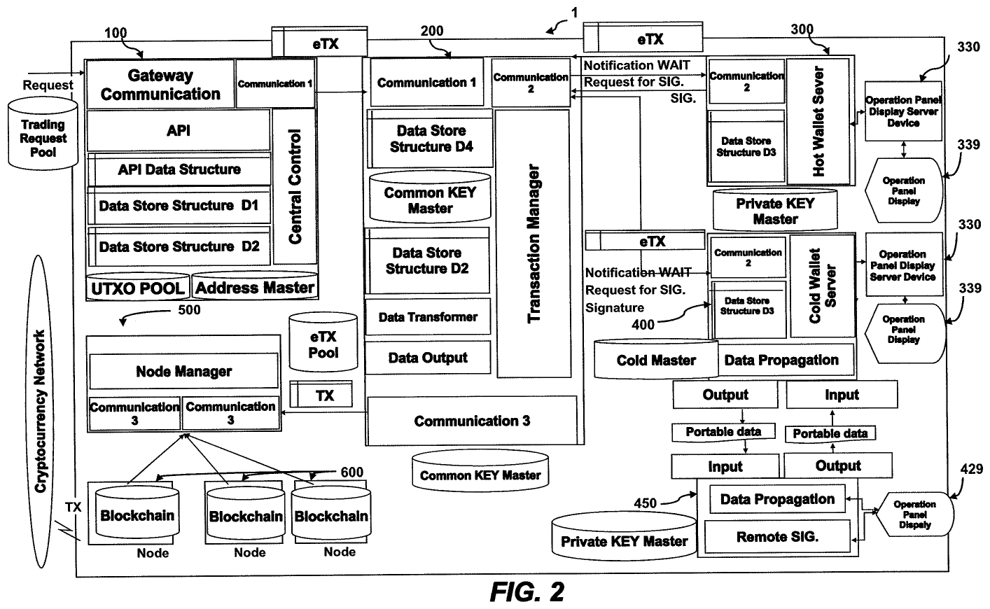

The embodiment of the wallet device 1 for the present invention is described in detail below. FIG. 2 illustrates the wallet device 1, comprising a central control server device 100 accepting trading request data from external, a transaction manager device 200, a hot wallet server device 300, a cold wallet server device 400 and a signature device 450, further including plurality of node devices 600, wherein the node device 600 is one of constitution members in bitcoin network, the wallet device 1 further includes a node manager device 500 there arranged in-between the nodes 600 and transaction manager device 200 to allow to broadcast to bitcoin network over internet through node devices 600.

As illustrated in FIG. 2, the central server device 100 of the wallet device 100 receives user request and creates proto-model transactions to transmit as unsigned transactions to transaction manager device 200. The transaction manager device 200 equipped with a communication unit for receiving unsigned transactions and be capable to transmit a request for signature to the hot wallet server device 300 or cold wallet server device 400, while the transaction manager device 200 has a functional unit to validate the unsigned transaction if the unsigned transaction has sufficient signatures conforming the specified condition for trading, to perform data conversions to transform into bitcoin standard transaction, and capable to transmit bitcoin transactions to the node manager device 500. The hot wallet server device 300 equipped with a unit to sign signatures in the device online in the network, and equipped with a unit to promptly send back signatures to the transaction manager 200. In option, the hot wallet sever device 300 may be equipped with an operation panel display device 339 capable to display a prompt for signature approve through an operation display server unit, wherein approver can specify and input a signature at the operation panel display.

The cold wallet server device 400 having a unit for data propagation to output a physical medium of signature request for the signature device 450 arranged in remote, including a printing unit using printer mechanism, while the cold wallet server device 400 is comprising a unit for data propagation to read another physical medium having the signature from the signature device 450 in remote, for examples, a reader unit data input device of an optical scanner, the cold wallet server device 400 having a communication unit to transmit the signature to transaction manager device 200. The cold wallet server device 400 may be equipped with an operation panel display device 339 capable to display a prompt for data propagation action, wherein an approver can specify and input a data propagation input/output at the operation panel display. Optionally, the cold wallet server device 400 may be equipped with an operation panel display device 339 capable to display a prompt through an operation display server unit 330.

The remote signature device 450 arranged remotely from the cold wallet server device 400, having a data propagation unit for receiving the request for signature by accepting the physical medium, being configured with a signing internally in the device, is provided with an outbound data propagation unit from the remote signature device 450 to the cold wallet server device 400. The remote signature device 450 may be equipped with an operation panel display device 439 capable to display a prompt for data propagation action, wherein an approver may specify and input a data propagation input/output at the operation panel display. The details for each device is described below.

The central control server device 100 includes a computer hardware comprising a CPU, a memory unit and a network unit, and a software operated on the operating system which control the hardware, by which the central control server device is driven and controlled, the central control server device 100 further including a first communication unit, application programming interface module 110 (denotes API hereafter), central control module 120, respectively, wherein some part of modules may be constituted of a software.

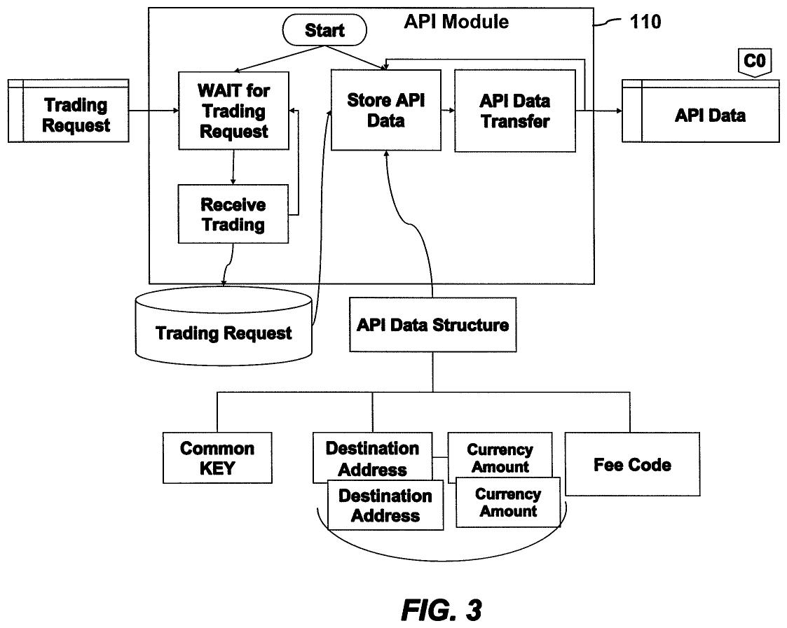

The central control server device 100 receiving a trading request through a gateway communication unit, converting the trading request data of user own data format into a wallet internal data format to conform to be processed in the wallet device 1, the wallet internal data format including:
1) one or plurality of master common keys to specify a source address;
2) one or plurality of a destination address;
3) payment cryptocurrency amount,
   the converted data being storing and holding in API (API denotes Application Program Interface, hereafter) data store structure in a computer memory unit. The master common key identify an address in the wallet device 1, identifying a signature protocol associated with the address. API data structure of an embodiment comprising a master common key, associated with a payment source address (not shown in FIG. 2, however illustrated in FIG. 3). API data structure, comprising addresses, which is an alphamerical string of bitcoin network address derived by a private key through a public key is exposed in public in bitcoin network, disclosing a fund owner and cryptocurrency amount (bitcoin amount in the embodiment). Optionally, API data structure may include an item:
4) transaction fee code,
   the transaction fee code in API data items determines dynamically per trading request for the bitcoin transaction processing fee for mining process payable to miner in bitcoin network whether to be due to the payment source address fund owner or due to the payment destination address fund owner. The transaction fee code requests no intervention by an operator, even if the expenditure amount is depending upon the fee. In addition, the API data in internal use for the wallet device are to be converted from the individual data format depending on preference of each client, providing the effect that customized processes with customized data are minimized. The embodiment illustrated in FIG. 2, API is included in the central control device 100 of the wallet device 1. Alternatively, API may be included in an application gateway server, not illustrated in FIG. 2, as API provide a function as an application gateway or the like.

later of API module 110, a copy of request data is sent to central control module 120 per request from API data store structure data in memory stored in API structure data.

Central Control module 120 creates an original transaction of internal format in the wallet device 1, by adding extended data (denotes extended-transaction, eTX hereafter) to bitcoin transaction data format, based on the API data received through a communication unit from API module 110.

The extended transaction could be created by reference to an address master M1, which stores data the master common key which is included in API Data structure or data store structure D1 which holds information data regarding with address, structured by the master common key. Therefore, an address may be replaced by another internal data presentation of named “master common key” preventing cryptocurrency address exposure, achieving more secure advantage for the current invention.

In the central control server device 100 includes, an address master, the address master holding at least the first data store structure D1 therein, for the reference use to identity the address. The first data store structure data in memory comprises data items including:
1) a master common key field corresponding to the address;
2) key sequence number;
3) the address in the cryptocurrency network.
   Here, the wallet device 1 of the present invention, uses private keys created by a deterministic wallet. The private keys created by a deterministic wallet has an advantage of recreating by using a seed and a key sequence number, even when the private key are not held in the wallet device.

The first data store structure include partial information to recreate the private key, therefore by locating seed information in another distributed data store structure, the risk of unintentional recreation of the private key by an intruder may be avoided.

The master common key included in the first data store structure data, wherein introducing “common key” (denoting “master common key”, hereafter) for showing keyed data relating to the same address, realizes multiple parts constitute the wallet device arranged partially distributed by using the master common key. Distributed arrangements for the server devices may be realized in various means, for examples, it can be achieved by a software module configuration, software module configuration in another server distributed arrange and the like.

The extended transaction includes the data structure described below. For a unsigned transaction which is a container to receive a signature, a second data store structure and structure data thereof are defined so as to hold the unsigned transaction, wherein the unsigned transaction comprises transaction input data items, transaction output data items corresponding to bit coin transaction structure and extended transaction data structure.

Transaction input data field items including one or plurality of sets of group data items 1), 2) and 3) listed below, being conformed to bitcoin standard transaction input data items:
1) payment source address;
2) prev hash; and
3) prev hash output index,
   further including one or plurality of pairs of data items 4) and 5) listed below, being conformed to bitcoin standard transaction output data items:
4) destination address; and
5) amount of the cryptocurrency,
   wherein data items listed 1), 4) and 5) are provided from API data through API data structure, data items 2) and 3) can be derived from 1). Further, the second data store structure including listed extended transaction data items correspond to each bitcoin standard transaction input:
6) a master common key to identify the public key corresponding to the second data store structure data; and
7) key sequence number data having used in a deterministic wallet creation,
   For examples, data items 6) and 7) may be derived the first data store structure stored in an address master M1. Further every transaction input include:
8) one or plurality of signature fields to store the signatures, wherein the number of signature fields may be allowable maximum number of the signature. Further, as a eTX (denoting extended transaction) extended transaction data items the second data store structure including:
9) transaction status code data field to store an identifier for status for the signature or signed status, at least 3 categories such as wait, or signed and transmitted status, shall be included, respectively.

Including extended data items of extended transaction eTX provide to separate transaction creation from signing transaction functionality, such distributed configuration improve security. Further, wallet device of the present invention provides an aggregated data store for the all of the plurality of signatures required in a transaction, therefore even for distributed signing processing of multi-signature, there provided an effect for operators intervention to be avoided.

Prior art provides the functionality for unspent transaction output (UTXO denotes Unspent Transaction Output hereafter) may be selected from available UTXO pool to create a transaction input corresponding payment request amount, wherein the wallet device 1 also has such a functionality therein. In the embodiment, UTXO pool illustrated in FIG. 2.

Upon the creation of an extended transaction eTX, promptly eTX is allowed to be transmitted to transaction manager device 200 through a first communication module. Server authentication between the central control server device 100 and transaction manager device 200 may use a message authentication, for examples, hash-based message authentication code (H-MAC), message authentication using proof of HMAC, the first communication module adopting a mnemonic code as a private key of crypto communication, such communication authentication and the like may be applied between server communication. Applying communication authentication between servers, the present invention further provides advantage of being more secure. Even the central control device 200 has a connection pass to internet, the transaction manager device 200 requesting signature to signature devices is free from direct internet connection, the connection having function with communication authentication between servers, intrude from externally can be prevented, therefore for the wallet device 100 of present invention provides essentially secure effect for the wallet device 100 of present invention.

Transaction manager device 200 equipped with an hardware system having CPU, a memory unit, an input unit, an output and a network unit, operating system to control the hardware, and configured with a software installed in the operating system is controlled through the software, comprising a first communication module, the second communication module, the third communication module, transaction manager module 210, data transformer 240 and data output 241, part of which may be consist of software.

Transaction manager device 200 configured to be able to receive extended transaction eTX through a first communication module from the central control server device 100 with communication authentication between servers. Unsigned extended transaction having an extended transaction structure may be transferred to transaction manager module, while the extended transaction may be stored in the second data store structure in an extended transaction pool. The master common key required to sign the transaction is received corresponding to extended transaction, may be stored in extended transaction pool.

When the multi-signature scheme is adopted, a master common key and plurality of seeds are required to complete multi-signature, such information shall be included in the fourth data store structure D4, which is held in common key master. The transaction manager module is configured to read the common key master, and the transaction manager may store the master common key into the data store structure D4 in memory. When the multi-signature scheme is adopted, the sufficient number of signatures to validate the transaction being known to the transaction manager device, the maximum number of signature fields for holding the signatures may be determined. Further, the signature status in the extended transaction may be updated by the transaction manager module 210.

The transaction manager device 200 is configured to be able to communicate through the second communication module with hot wallet server device 300 of a signature equipment online to network. Transaction manager module 210 is configured to accept through the second communication module a polling for waiting for the request for signature. At receiving receive the polling from the hot wallet server device 300 or just later in receiving the polling, the transaction manager module may be configured to receive the master common key to select an unsigned transaction from the hot wallet server device 300. Transaction manager module 210 may be configured to read extended transaction eTX from extended transaction pool into the fourth data store structure D4 in memory, transaction manager module 210 further configured to be able to perform matching the master common key for the data store structure D4 in the extended transaction and for the data in the polling for waiting for the signature request. The transaction manager module 210 is configured to select an unsigned request having the same common master key contained in the extended transaction input as that of data in polling waiting for request for the signature, and further the transaction manager module 210 may be configured to set transaction status in the extended transaction into UNSIGNED status for the data store structure D4 data in memory, and then transmits the request for signature to the hot wallet server device 300 through the communication 2 module. The transaction manager module 210 may be further configured to synchronize the transaction status of the extended transaction stored in the extended transaction pool as UNSIGNED, with that of extended transaction for data store structure D4 data in memory.

The transaction manager device 200 is configured to communicate with the cold wallet server device 400 through communication 2 module, wherein the cold wallet server device 400 may control an offline signature device under the operator's intervention. Transaction manager module 210 is configured to accept through the second communication module a polling for waiting for the request for signature. Upon receiving the polling from the cold wallet server device 400 or just later in receiving the polling, the transaction manager module may be configured to receive the master common key to select an unsigned transaction from cold wallet server device 400. Transaction manager module 210 may be configured to read extended transaction eTX from extended transaction pool into the fourth data store structure D4 in memory, transaction manager module 210 further configured to be able to perform matching the master common key for the data store structure D4 in the extended transaction and for the data in the polling for waiting for the signature request. The transaction manager module 210 is configured to select an unsigned request having the same common master key contained in the extended transaction input as that of data in polling waiting for request for the signature, and further the transaction manager module 210 may be configured to set transaction status in the extended transaction into UNSIGNED status for the data store structure D4 data in memory, and then transmits the request for signature to the cold wallet server device 400 through the communication 2 module. The transaction manager module 210 may be further configured to synchronize the transaction status of the extended transaction stored in the extended transaction pool as UNSIGNED, with that of extended transaction for data store structure D4 data in memory. As described above, the transaction manager module 210 is configured to be able to drive equally the hot wallet server device 300 and the cold wallet server device 400, therefore the overall configuration flexible for arranging of plurality of the signature devices may be attained, because the system requirement difference between the hot wallet signature and the cold wallet signature are absorbed in the functional difference of the hot wallet server device 300 and the cold wallet server device 400. Such configuration, therefore, contributes to simplify the signature flow control of transaction manager module 210, providing more processing capacity and providing means to enable shorter polling response time.

The transaction manager module 210 may be configured to check the content of the signature field in the extended transaction input upon receiving the signature, to verify the specified signature requirement to complete transaction signature. Further, the success verification for all the extended transaction signature input contained in the transaction enable the transaction manager module 210 to update the extended transaction status field as SIGNED status, which indicates all the signature are fulfilled. Then, the extended transaction status in the extended transaction data stored in extend transaction pool may also be updated to SIGNED status.

Data transformer module 240 may be configured to transform the extended transaction eTX with SIGNED status into standard bitcoin transaction TX.

The data output module 241 may be configured to transmit the bitcoin transaction TX data to the node manager device 500 through the third communication module using communication authentication between servers. Authentication between servers may be configured like that of the first communication module, using a message authentication, for examples, hash-based message authentication code (H-MAC), message authentication using proof of HMAC, the third communication module adopting a mnemonic code as a private key of crypto communication, such communication authentication and the like may be applied for the communication authentication between servers.

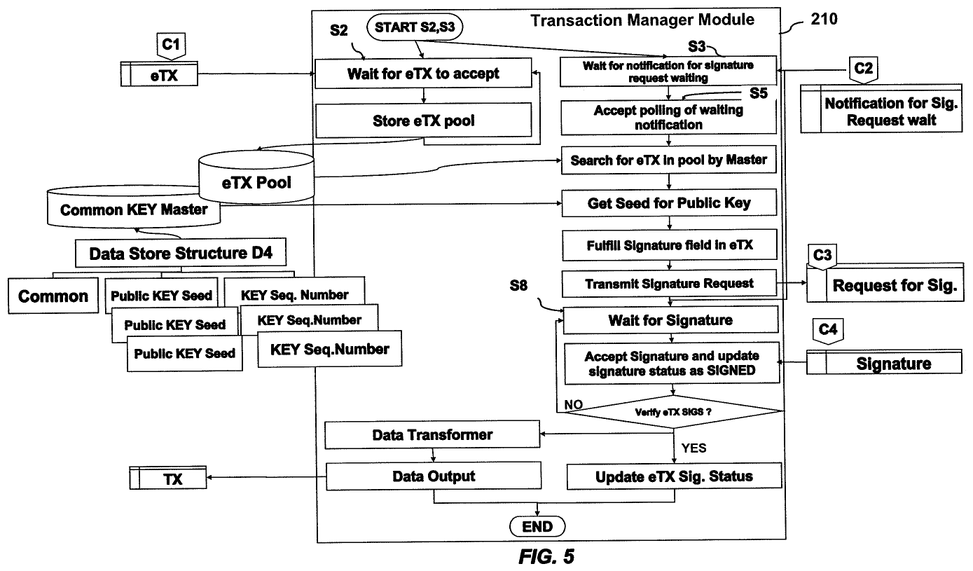

Upon completion of signing, the processing flow control of data output module 241, may be attained by the control through transaction manager module 210, therefore the transaction manager module 210 may update the extended transaction status into SENT in the data stored in the extended transaction data on the extended transaction pool upon completion of data output processing through data output module 241. Optionally, the data transformer module 240 and data output module 241 may be included as sub-modules in the transaction manager module 210 as illustrated in FIG. 5.

The hot wallet server device 300 is equipped with an hardware system having CPU, a memory unit, an input unit, an output and a network unit, operating system to control the hardware, and configured with a software installed in the operating system. The hot wallet server device 300 is controlled through the software, and comprises the second communication module, hot wallet server module 310, part of which may be consist of software.

The hot wallet server device 300 may be configured as a signature device online to network, configured to send a notification for being ready for accepting the request for signature through the second communication module to transaction manager device 200, further may be configured as polling communication enabled.

In response to send the polling, or later of the polling, the hot wallet server device 300 may receive request for signature from the transaction manager device 200 through the second communication module. The request for signature may include an unsigned transaction, and the hot wallet server module 310 may recreate the private keys required to sign by the deterministic wallet architecture, by the allocated information to the hot wallet server device 300 and the information contained in the extended transaction. Optionally, the private key itself may be included in the private key master, readable by the hot wallet server module 310. As the allocated data, the hot wallet server device 300 may read a seed for private key from the private key master, and then such information may be combined with the key sequence number which is the extended part of the extended transaction eTX to organize the data structured by the third data store structure D3 data in memory, by which may recreate the private key.

The hot wallet server module 310 may sign the unsigned transaction by using the private key, To create the signature, the hot wallet server module 310 may use the standard bitcoin structure which is an internal part of the extended transaction structure, wherein the hash value may be calculated by prior art known to a person skilled in the art, and then may complete electronic signature by using digital signature algorithm ECDSA.

The hot wallet server module 310 may configure to be able to communicate with an operation panel display server device connected to the hot wallet server device 300, and the operation panel display connected to the operation panel display server device may be configured to display operation input screens, wherein the operation input screen enables to input approvals through the operation panel display. For examples, a prompt may be displayed to request to determine whether the amount contained in a transaction input less than the specified amount or not, and then the prompt may accept the approval for signing by operators. Upon approval of the signature by approvers through online display, the hot wallet server module 310 may create the signature promptly, and may send the signature to the transaction manager device 200 through the second communication module. Authentication between the operation panel display and the operation panel display server device may be configured by SSL (Secure Socket Layer) communication for both sides of the communication units.

The cold wallet server device 400 is equipped with an hardware system having CPU, a memory unit, an input unit, an output and a network unit, operating system to control the hardware, and configured with a software installed in the operating system, the cold wallet server device 400 is controlled through the software, and comprises the second communication module, cold wallet server module, and data propagation module, part of which may be consist of software.

The cold wallet server device 400 may be configured as a signature device offline to network, configured to send a notification for being ready for accepting the request for signature through the second communication module to transaction manager device 200, and the cold wallet server device 400 further may be configured as polling communication enabled.

In response to send the polling, or later of the polling, the cold wallet server device 400 may receive request for signature from the transaction manager device 200 through the second communication module. The request for signature may include an unsigned transaction.

The cold wallet server device 400 may comprise a portable data output device, for examples, a QR code printing device, wherein the portable data output device may be IO connected to the cold wallet server device 400, wherein the cold wallet server device 400 may output the printing data to the QR code printing device through the data propagation module.

The cold wallet server module may be configured to be able to communicate with the operation panel display server device connected to the cold wallet server device 400, prompt for printing instruction report for the portable data output, and then the operator may input a printing instruction for signature through the operation panel display screen. The signature instruction report may include OR code. Authentication between the operation panel display and the operation panel display server device may be configured by SSL (Secure Socket Layer) communication for both sides of the communication units.

The cold wallet server device 400 may include a portable data reader IO device, IO connected to the cold wallet server device 400, wherein the portable data may be a print report including a OR code therein, and the OR code printed report may be digitized by using a scanner device, being readable as the signature by the processing in the data propagation module. The cold wallet server device 400 may be configured to accept the data as signature, and the signature may be transmitted to transaction manager device 200 through the second communication module.

The cold wallet server device 400 may be configured to locate in remote site different from the hot wallet server device 300. In the specification herein, the terminology of “remote” means remote site to the hot wallet server device 300 or remote site to the transaction manager device 200, implying the nature of the cold wallet server device 400, more secure environment under the controlled by human resource, therefore the remote site may be another partitioned area in the same floor, another floor or another building or the like.

The cold wallet server device 400 may be configured to locate in remote site different from the hot wallet server device 300, wherein such a configuration have an advantage of signer centric.

The plurality of cold wallet server device 400 may be configured one of which may be located in remote, examples Osaka to Tokyo and the like, wherein such a configuration has an advantage of improving the security for the disaster recovery.

The remote signature device 450 is equipped with an hardware system having CPU, a memory unit, an input unit, an output and a network unit, operating system to control the hardware, and configured with a software installed in the operating system, and the remote signature device 450 is controlled through the software, remote signature unit and data propagation unit, part of which may be consist of software.

The remote signature device 450 may be configured in remote to the cold wallet server device 400, offline environment of unconnected to external network, wherein the remote signature device 450 may be configured to read portable data including signature instruction output by cold wallet server device 400 and the read data are to be accepted after processing in the data propagation module.

The remote signature device 450 may be configured as IO (IO denote Input and/or output hereafter) enabled, wherein the operation panel display connected to the remote signature device 450 may display a prompt for operation instruction to read portable data, and the operator may input a signature instruction through the operation panel display to create a signature. The portable data accepted by the remote signature device 450 may include an unsigned transaction, and the remote signature device 450 may recreate the private keys required to sign by the deterministic wallet architecture, by using the allocated information to the remote signature device 450 and the information contained in the extended transaction. Optionally, the private key itself may be included in the private key master, readable by the remote signature device 450. As the allocated data, the remote signature device 450 may read a seed for private key from the private key master, and then such information may be combined with the key sequence number which is the extended part of the extended transaction eTX to organize the third data store structure D3 data in memory, by which may recreate the private key. By using the either of the means described above, the remote signature device 450 may sign the unsigned transaction by using the private key, To create the signature, the remote signature device 450 may use the standard bitcoin structure which is an internal part of the extended transaction structure, wherein the hash value may be calculated by prior art known to a person skilled in the art, and then may complete electronic signature by using digital signature algorithm ECDSA. By using the either of the means described above, remote signature device 450 may sign the unsigned transaction by using the private key. The remote signature device 450 may display a prompt for printing instruction report for the portable data output, and then the operator may input a printing instruction for signature through the operation panel display screen. According to the instruction, the signature may be output by the 10 connected portable data output device, wherein, for examples, the printing report with a QR code may output by printer after processing in the data propagation module.

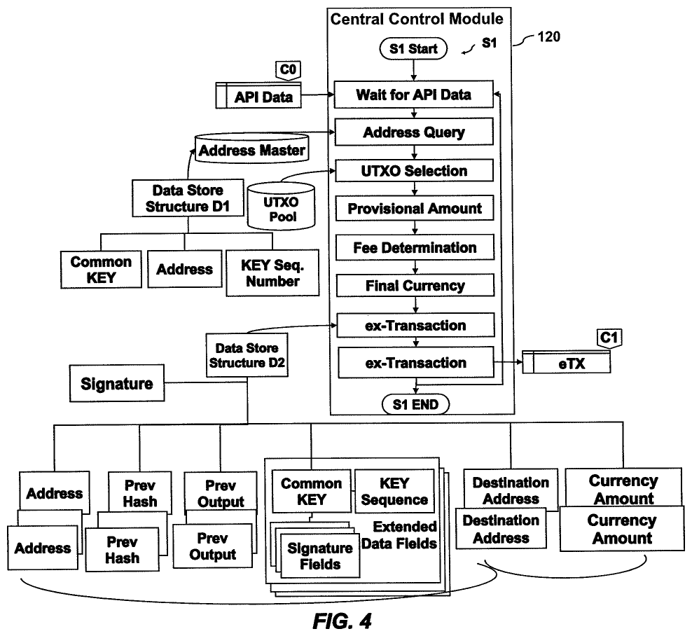

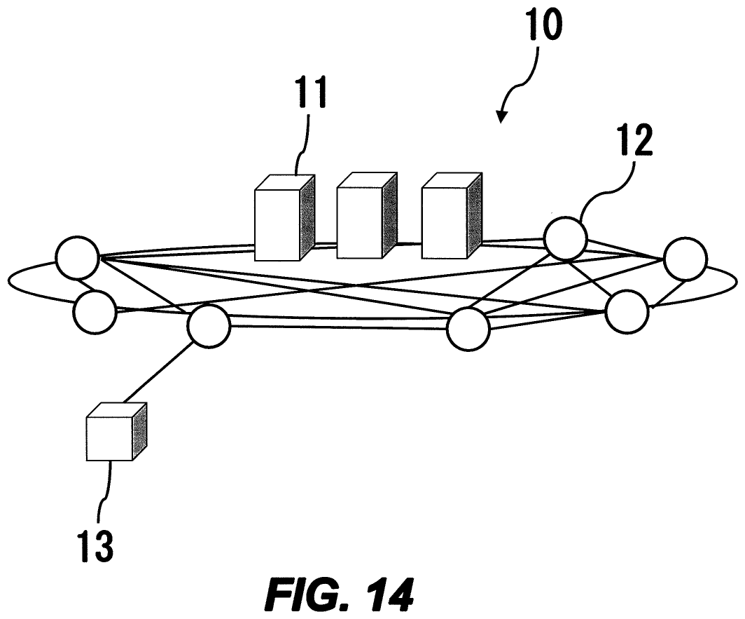

Next, a processing of the present invention are described hereafter with the processing flow chart for a software installed in an operating system on the wallet device 1, as illustrated in FIG. 3-8. FIG. 14 illustrates a embodiment of a method of signature used in several embodiments of the present invention, corresponding to the description according to FIG. 4-8.

A central control server device illustrated in FIG. 1 is equipped with an hardware system having a CPU, a memory unit and an operating system to control the hardware, wherein the central control server device is configured to be operational by a software installed in the operating system.

The API unit may be configured as part of a software installed on an operating system on a central control server device, and the API unit shall be an API module 110. The API module 110 operates as a flow chart illustrated in FIG. 3. The API module 110 converts interfaced user data into the internal format data to be used in the central control module. Optionally, An API unit could be part of the software installed and being operating on an operating system in a gateway server device arranged between user system and the central control server, in that case, the API unit may be connected in network through communication unit in the gateway server device to the central control server device.

Starting the API module, the first step 111, waiting for trading request step is to be initiated, for examples in an embodiment, waiting for trading request is a step such that waiting for a trading request from the external system managed by a cryptocurrency exchange trader. Upon receiving a trading request from an external system, for examples through computing network (network hereafter denote computer network), waiting for trading step request initiates the next step 112, Receiving Trading Request step, wherein Receiving Trading Request step 112 stores trading request data in a trading request pool and the flow control shall return to step 111 of waiting for trading request step.

The API module 110 reference the trading request pool in parallel to the waiting for trading request step 111, if the record exits, the control transits to, step 113 of API Data Store, wherein in step 113 the data record in the trading request pool is to be converted and stored in the API Data Structure. Next flow control, promptly, entering API Data Transfer step, wherein the API Data Transfer step transfers API data to the central control module after conversion from user specific data format to the internal data format suitable to the wallet device 1, after the completion of the step, the control shall be return to step 113 of API data store, continuing processing in loop.

API data store structure is the data structure illustrated in FIG. 3. API data store structure has 5 data items:

a master common key specifying a payment account; payment amount for the payment account, at least one group of master common key and payment amount; destination address as transfer account; payment amount for the transfer account, at least one group of destination address and transfer amount; transaction fee cover code to determine the party concerned to be payable for the transaction fee, wherein all the data items are included in request data.

The central control unit 120 may be configured as part of a software installed on an operating system on a central control server device 100, and the central control unit shall include an central control module 120.

The central control module 120, operates according to a system flow chart illustrated in FIG. 4. As for a signing processing, the central control module 120 stores a user bitcoin transaction request data in the data format suitable to process in wallet device 1 and then transfer the data to the transaction manager module as a unsigned transaction data.

When the central control module 120 is initiated, it promptly pass the system flow control to step 122, Waiting For API Data. Upon receive request data as API Data store structure data, through a means in-between modules, for examples in-process data communication. from API module, an unsigned transaction creation shall be initiated. In the next system flow control step 122, Address Query, a master common key may be retrieve in API data, which shall be used a master common key in succeeding entire system flow across in the wallet device 1. In the next flow control, in step 123 of UTXO Selection, UTXO records shall be selected for the master common key matching condition, according to a specified priority rule defined, one or plurality of UTXOs shall be retrieved to be aggregated to meet the payment request amount of cryptocurrency. And then, in step 124 of Provisional Amount, sum of one or plurality of UTXO to be used for transaction inputs, and UTXO to be used for transaction outputs according to payment request instructed by a user shall have been determined, and then the differential amount shall be calculated to create additional transaction output. And then, in step 125 of Fee Determination, UTXO for mining fee shall be added by reference to the transaction fee cover code which indicates whether the transaction fee is due to the payment source party or destination party, wherein the mining fee may be calculated as the differential amount between sum of transaction inputs and sum of transaction outputs. And then, step 126 of Final Currency Amount, all the data items in the transaction, such as transaction input, transaction outputs, mining fee as the difference between sum of transaction inputs and sum of transaction outputs shall be checked and Finalized. If necessary, the additional UTXO is added to transaction output. And then, in step 127, Extended Transaction Transmission through reference to the second data store structure, the transaction inputs data items and transaction outputs data items shall be allocated.

The second data store structure comprises general bitcoin transaction data items and extended transaction data items introduced by the present invention, wherein the former data items may be derived from UTXOs required by the API data structure data except for the data items associated with the signature. The transaction data items corresponding to bitcoin transactions are the same technology as the prior art, while the master common key, one of the extended data elements, is an internal information data style expressed in the wallet device 1, used to identify the UTXO selected by query in UTXO pool. The key sequence number is to create a public key corresponding to the private key for signing to approve the use of effective in current UTXO, The extended data structure may be constructed by reference to the address master storing data of the first data store structure. The number of the signature field may be prepared to be the maximum number for required signatures. The mandatory information for signing are not fulfilled within the central control server module, therefore the wallet device 1 of the present invention is more secure to the external intruders.

Upon constructing an extended transaction based on the second data store structure, the control shall be transferred to step 127, Extended Transaction Transmission, wherein the extended transaction shall be transmitted through the first communication unit. The system flow control shall return the execution to step 122, Waiting for API Data, continuing process in loop.

The transaction manager unit may be configured as part of a software installed on an operating system on a transaction manager device 200, and the transaction manager unit 210 shall include an transaction manager module 210.

The transaction manager module 210 operates according to the system flow illustrated as FIG. 5. Roughly speaking, the transaction manager module comprises a first part of the module and the second part of the module, wherein the first part accepts the extended transaction through the first communication module 201, and the second part control the system flow including communication in network for performing the signature. Upon initiating the module, the first part of the transaction manager module enters step 211, wait for extended transaction eTX and then, upon accepting an extended transaction through the first communication unit, promptly the control transferred to next step, Store eTX POOL, storing the accept data into extended transaction pool.

Upon initiating the transaction module 210, in parallel to step 211, wait for extended transaction eTX accept, step 221, wait for notification for signatures request wait shall be initiated, upon receiving a notification of signature wait through the second communication unit, the system flow control shall be transferred to step 222, accept polling of waiting notification. And then, unsigned transactions having the same master common key included in the notification for signature wait searched for in the extended transaction pool by query, and select target unsigned transaction to be signed. And then, in the next step 224, Get Seed for Public Key, a seed used in creating a public key corresponding to the group set of the master common key and the key sequence number by reference to the common key master, wherein the master record data in the common key master are structured according to the data store structure D4. And then, a selected extended transaction has a description in script fields of a transaction input of UTXO, describing the required signature scheme such as multi-signature. For examples, the multi-signature defines the total number of signatures corresponding to the private keys and the required number of signature to be approved, which determines the framework of the signature fields. For examples, in 2-of-3 multi-signature scheme, among 3 private keys for signatures in total, two signatures are mandatory to approve the use of the UTXO. And then, step 226, Transmit Signature Request accompanying with a selected unsigned transaction shall be transmitted through the second communication module 202. And then the system control flow has a branch to return to step 221, wait for notification of signatures request wait and another branch leads to step 227, Wait for Signature. Upon receiving the signature, the control shall be transferred to step 228, Accept Signature and update signature status as SINGED, to update one of the signature fields as Signed. And then, in the next step 229, Verify eTX Signatures verifies whether 2-of-3 multi-signature scheme has been satisfied or not, and if YES, in the one of the branch flow step 250, updates eTX signature status as SIGNED, and the another branch flow step 240, Data Transformer, transforms extended transaction eTX formatted data into bitcoin transaction TX formatted data. And after step 240, the control enters step 241, Data Output, transmits bitcoin transaction data through the third communication unit to the node manager device 500.

In the next step 229, Verify eTX Signatures, verifies whether 2-of-3 multi-signature scheme has been satisfied or not, accordingly if NO, the flow return the control back to step 227, Wait for Signature, accordingly the step 227-229 shall be repeated.

The fourth data store structure D4 comprises three of data items, as illustrated in FIG. 5. A master common key representing a common internal address in the wallet device 1, a public key seed derived from a corresponding a private key seed and key sequence number indicating the sequence order for the deterministic wallet scheme, wherein the private key is mandatory to create a signature. For examples, multi-signature scheme requires plurality of public keys and private keys under a master common key. The fourth data store structure D4 comprises public key seeds and key sequence numbers, wherein the public keys may be created by using public key seeds and key sequence numbers. A master common key and a key sequence number are included in the data items of extended transaction, accordingly the data store structure enables to identify the private key through the corresponding public key created by the corresponding public key seed and key sequence number.

The third data store structure for the private key is corresponding sub-set structure of the fourth data store, and may comprises two of data items within:

a master common key representing a common internal address in the wallet device 1;
a private key seed necessary to create signature: and
key sequence number indicating the sequence order for the deterministic wallet scheme. For examples, multi-signature scheme requires plurality of private key seeds, private keys under a master common key. The third data store structure D3 may accept one private key seed retrieving from private key master, while a request for the signature includes the extended transaction with key sequence number which is stored in the extended transaction data items in transaction input, and the key sequence number and the private key seed may create the private key. Therefore, it may be sufficient to read the master common key and a private key seed from private key master M3. Optionally the private key master may have redundant configuration such as including plurality of private key seeds set in the master common keys.

The hot wallet server unit may be configured as part of a software installed on an operating system on a hot wallet server device 300, and hot wallet server unit shall include an hot wallet server module 310.

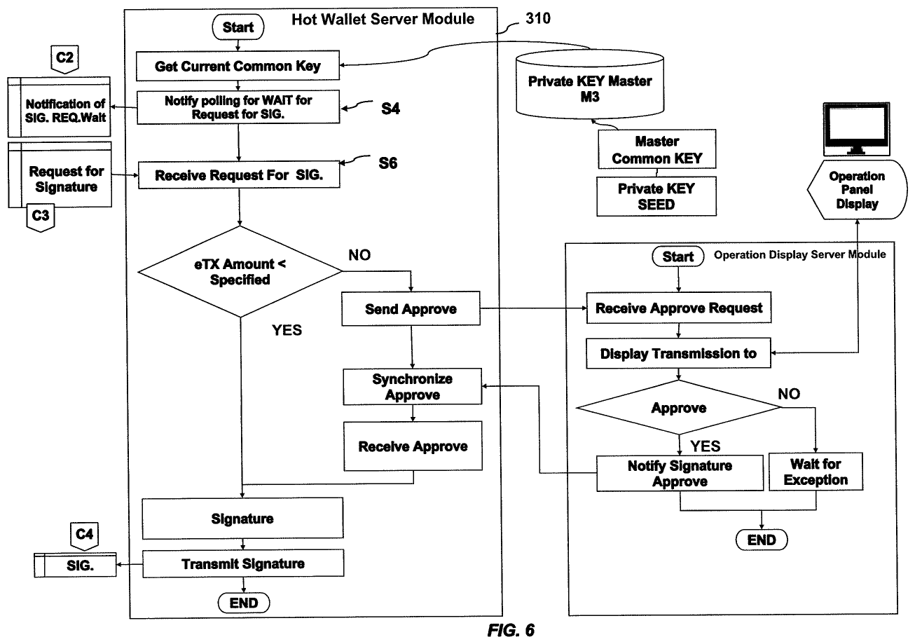

The hot wallet server module 310 operates according to a system flowchart illustrated in FIG. 6. Upon initiation of the hot wallet server module 310, Step 311, Get Current Common key, for examples, reads a master common key and a private key seed and stores the common key and the private key seed in the corresponding data elements in the third data store structure data in memory while in step 311 the master common key allocated to hot wallet server module 310 may be recognized. And then, in step 312, Notify Polling for WAIT for Request for Signature, transmits notification of signature request wait by polling through the second communication unit to the transaction manager module 210 indicating that the hot wallet server module 310 is ready for accept request for signature. The master common key may be transferred accompanied at polling to the transaction manager module 210. The transaction manager module 210 is waiting for the polling in step 222, Accept Polling of Waiting Notification, as described above. And then the hot wallet server module waits for receiving a request for signature to receive request for signature in step 313, Receive Request for Signature, sent from the transaction manager module 210 at Transmit Signature Request step 226. The signature request includes an unsigned transaction. And then step 314 is a verification step whether the total payment amount of transaction input included in the transaction, which corresponds to the total amount used in UTXO, is less than the specified amount to determine the approval need for the intervention by operators at transfer. Upon success in the verification, the system flow control enters Signature step 370 for signing. In failure in the verification, the system flow control enters exception branch step of Send Approve request to send approve request to the operation panel display 339 through an operation display server module 330. After the initiation, the operation display server module 330 accepts the approval request for the operation panel display from the hot wallet server module 310 in Receive Approval Request step 331. And then, the operation display server module 330 displays an approval screen to prompt of input approval in the operation panel display 339 connected to the operation display server module 330. Upon the command input through the operation panel display 339, the operation display server module 330 receives the command through the connection. The next Approve step 333 verifies the command input through the operation panel display 339 for the exception criteria. If failure in Approve step 333, the system control flow branche to Wait for Exception step 340 to wait for the exceptional operation, and then terminate the flow. If success in Approve step 333 branche to Notify Signature Approve step 350, and then transmitting the signature approval, and then the operation display server module 330 flow shall terminate.

The hot wallet module 310 enters Synchronize Approve step 316, upon having transmitted an approval in Send Approve step 315, waiting for the approval until receiving the approval from the operation display server module 330. If failure to receive the approval within the specified time window, the case of the exception shall be scheduled, therefore with the specified elapsed time, such an interruption as timer initiated timer interruption or software initiated interruption and the like preferably, interrupt the waiting status and them the process shall be terminated. Upon receiving the approval command input in Synchronize approve step 316, the hot wallet server module 310 recognize the signature approval in Receive approve step 317, join after verification step 314 of whether the total payment amount of transaction input included in the transaction?, entering Signature step 318. In step 318, according to the logic of the deterministic wallet scheme, the private key shall be recreated by the private key seed stored in the third data store structure data and key sequence number so as to sign the corresponding UTXO contained in transaction input within the unsigned transaction. Using the standard bitcoin transaction part in the extended transaction structure to create the signature, so that hash value shall be obtained by using the disclosed well known prior art to a person skilled in the art, whose scheme has been defined in the bitcoin architecture, wherein the electronic signature shall be applied to the hash by using digital signature algorithm ECDSA well known to those skilled in art. And then, in Transmit signature step 319, the signature shall be transmitted to transaction manager module 210 through the second communication unit.

In the transaction manager module 210, in Wait for Signature step 227, upon the receiving the signature, entering step 228, Accept Signature and update signature status as SIGNED, as described above.

The cold wallet server unit may be configured as part of a software installed on an operating system on a cold wallet server device 400, and cold wallet server unit shall include an cold wallet server module 410.

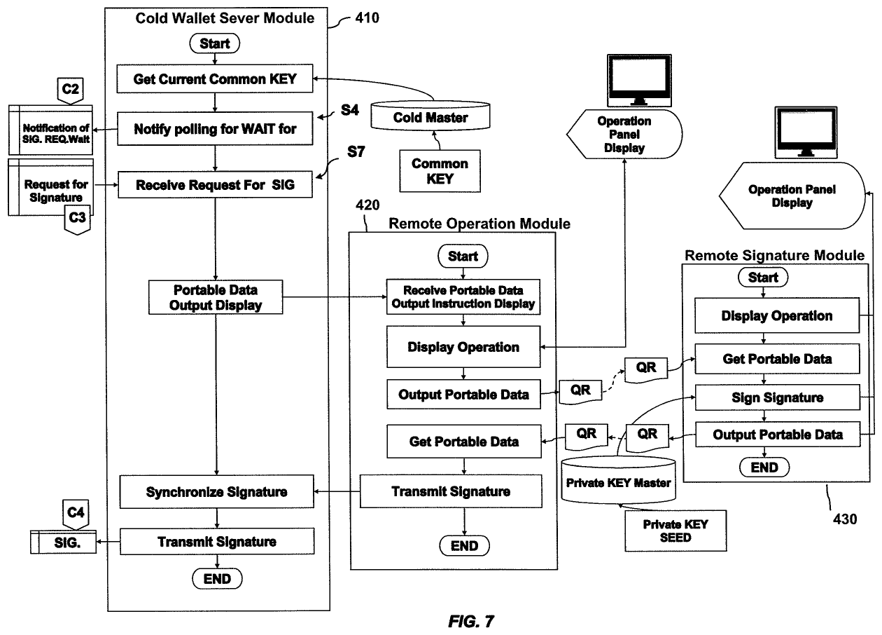

The cold wallet server module 410 operates according to a system flowchart illustrated in FIG. 7. Upon initiation of the cold wallet server module 410, Step 411, Get Current Common key, for examples, reads a master common key stored in cold master M3. And then the master common key allocated to cold wallet server module 410 may be recognized. And then, in step 412, Notify Polling for WAIT for Request for Signature, transmits a notification of signature request wait by polling through the second communication unit to the transaction manager module 210 indicating that the cold wallet server module 410 is ready for accept request for signature. The master common key may be transferred accompanied at polling to the transaction manager module 210. The transaction manager module 210 is waiting for the polling in Accept Polling of Waiting Notification step 222, as well as the hot wallet server module 310, as describe above. And then the cold wallet server module waits for receiving a request for signature to receive request for signature in step Receive Request for Signature 413, based on the information of signature request the portable data to the remote signature device 450 shall be prepared. And then Portable data Output Display step 414 transmits the portable data to the remote operation module 420 operating on the operating system in the remote computer device connected to the computer device which have the cold wallet server module 410 installed on the operating system. The remote operation module 420 may be configured in the another computer device with separate housing from the cold wallet server device 400 which have the cold wallet server module 410 installed on the operating system. Upon initiation of remote operation module 420, Receive Portable Data Output Instruction step 421 receives portable data output instruction through the connection with the cold wallet server module 410. And then, in Display Operation step 422, portable data output instruction screen data shall be sent the operation panel display 429 connected to the computer device (not illustrated in the figure) which have the remote operation module 420 installed on the operating system, displaying a prompt for data output instruction input. Upon accepting the input of data output instruction as an output command, Output Portable Data step 423 shall be invoked to operate the data propagation device (not illustrated in figure), for examples, OR code printer device, connected to the computer device which the remote operation module 420 installed on the operating system, printing out a signature request portable data (a sheet of OR code printed paper) according to operator's intervention, and then waiting for the signature return. And then operator shall bring the signature request portable data (a sheet of QR code printed paper) to the signature device secured area.

The remote signature unit may be configured as part of a software installed on an operating system on remote signature device 450, and remote signature unit shall include remote signature module 430.

And then a portable data reader device (not illustrated in the figure), for examples QR code reader device such as scanner device (not illustrated in the figure), connected to the remote signature device 450, shall be initiated by the remote signature module 420 which has been installed on the operating system in the remote signature device 450, to be in operation and then the portable signature request data shall be accepted in the remote signature device 450. In Signature step 433, according to the logic of the deterministic wallet scheme, the private key shall be recreated through the private key seed stored in the third data store structure D3 data and key sequence number so as to sign the corresponding UTXO contained in transaction input within the unsigned transaction. The third data store structure D3 data may accepted as a portable data propagation data media, alternatively the remote signature device 450 shall read the private key seed stored in the Private Key Master M3 and then the master common key and the sequence numbers accompanied with the signature request included in the portable data may be used to configure the third data store structure D3 data in memory. Using the standard bitcoin transaction part in the extended transaction structure to create the signature, so that hash value shall be obtained by using the disclosed well known prior art to a person skilled in the art, whose scheme has been defined in the bitcoin architecture, wherein the electronic signature shall be applied to the hash by using digital signature algorithm ECDSA well known to those skilled in art.

And then, in Output Portable Data step 434, portable data output instruction screen data shall be sent the operation panel display 439, displaying a prompt for data output instruction input. Upon accepting the input of data output instruction as an output command, Output Portable Data step 434 shall be invoked to operate the data propagation device (not illustrated in figure), for examples OR code printer device, printing out a signature portable data (QR code printed paper) with operator's intervention, and then the remote signature module terminates. And then operator shall bring out the signature portable data (QR code printed paper) to outside of signature device secured area. And then, in Get Portable Data step 424, a portable data read instruction screen data shall be transmitted to the operation panel display 429, presenting input prompt for portable data read instruction, and then receiving a portable data read instruction to accept as command input, and then a portable data reader device (not illustrated in figure), for examples a OR code reader device such as an optical scanner device (not illustrated in figure) shall be initiated by the remote operation module 420 operating on an operating system in the computer device (not illustrated in figure) so as to read the signature portable data storing the signature in memory on remote operation module 420. And then, in Transmit signature step 425, the signature shall be transmitted from the computer device which has the remote operation module installed to the cold wallet server module 410 via the connection with the computer device having the operating system which has the cold wallet server module installed. And then, the remote operation module terminates and in parallel Synchronize Signature step 415 on the cold wallet server module 410 receiving the signature to store in memory. And then, in Transmit Signature step 416, the signature shall be transmitted to the computing device which has the transaction manager module 210 installed on the operating system therein. While the transaction manager is in Wait for Signature step 227, in waiting for the reply to the requests for signature, upon receiving the signature, promptly accepting the signature to enter step 228, Accept Signature and update signature status as SIGNED, as described above.

In the embodiments above described, illustrated in FIG. 1, in the transaction broadcast to bitcoin network, the broadcast data are transformed from the extended transaction format to bitcoin transaction format and then broadcast through node devices.

The node device may be well know node device used in bitcoin network, optionally, in the present invention such an owner node unit may be equipped with the wallet device 1, providing the ownership governance and improving security.

The wallet device 1 in an embodiment of the present invention, optionally, further includes at least three of the owner node devices. The node device may be arranged in neighbor in the local network in the wallet device 1, in case the neighbor node device is in malice to make blockchain fake, the wallet device 1 may possibly be under the risk of being deceived by fake blockchain. The wallet device 1 in an embodiment of the present invention includes at least three of owner node devices, preventing the wallet device 1 from being surrounded by fake nodes and to have own nodes in neighbor of the wallet core unit leads to keep the diversity to get more secure, unintentional and more free from malice blockchain. Such multiple owner node arrangements enable to compare the blockchain each other among unintentional node sampling making more secure. Optionally, verification of the coincide between two owner nodes for blockchain may avoid the risk of fake, at least better than without such verification. Even though there is possibly a risk to have a fake node, coincide between two nodes may provide more secure evidence, therefore the fake risk could be avoided. Optionally, majority rule decision by the coincide between two owner nodes among three nodes provides the definite conclusion whether the blockchain is fake. Further, optionally majority rule decision by the coincide among five owner nodes may provide more certain conclusion whether the blockchain is fake. The wallet device 1 may be configured to perform such verifications in node manager device 500.

The node manager device 500 equipped with an hardware system having CPU, a memory unit, an input unit, an output and a network unit, operating system to control the hardware, and configured with a software installed in the operating system, The node manager device 500 is controlled through the software, comprises node manager module 510 and the third communication module, part of which may be consist of software.

The node manager unit may be configured to have means to set and to hold the number of own node devices, for examples, by having a node master data storage device to read the number of own node devices and to store the number in memory. The node manager unit may get at least latest part of the blockchain copy at least regular cycle period, through the node device 600, or node units or node modules if equipped within node manager device 500. The blockchain data may be read through the communication network between the node devices and the communication unit, for examples, based on the scheme such as WEB socket and the like suitable for bulk data communication.

The node manager unit may be configured as part of a software installed on an operating system on a node manager device 500, and node manager unit shall include an node manager module 510.

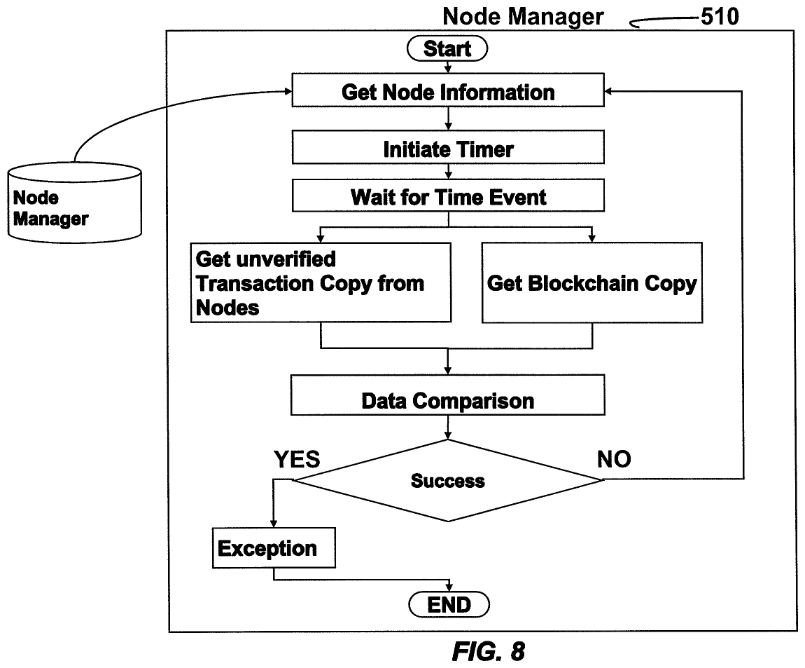

The node manager module 510 operates according to the system control flow illustrated as FIG. 8. The initiation of node manager module 510 starts Get Node Information step 511 to retrieve the verification condition to determine the true of node data from node manager storage to store in memory. And then, the system flow control to enter Initiate Timer step 512 to initiate system timer to enable regular time interval operation, and then on timer event occurring, Wait for Timer step 513 initiates Get unverified Transaction Copy step 514 and Get Blockchain Copy step. In step 514, unverified transaction shall be copied from each nodes to the node manager module 510 in structure data in memory and the data store structure data in storage connected to the node manager device 500. And then, Data comparison step 520 performs comparison between selected pair of the data store structure data. Verification shall be performed under the specified criteria for the true of the data own by each node. Success in verification in step 520 returns the control back to the start to initiate the timer and continues the flow in loop. Failure in verification in step 520 enters Exception step 521, performing exceptional procedures and then the node manager module terminate terminates. In parallel to step 514, in Get Blockchain Copy step 515, blockchain copy shall be copied from each nodes to the node manager module 510 in structure data in memory as well as being stored in structure data in the storage connected to the node manager device 500. And then, Data comparison step 520 performs comparison between selected pairs of the stored data. Verification shall be performed under the specified criteria for the true of the data by each node. Success in verification in step 520 returns the control back to the start to initiate the timer and continues the flow in loop. Failure in verification in step 520 enters Exception step 521, performing exceptional procedures and then the node manager module terminate terminates. For examples, there defined three nodes in the wallet device 1, the majority of three nodes, that is, any pair of the comparison shows the coincide, then the verification shall be SUCCESS and returns the control back to the start to initiate the timer and continues the following flow in loop.

By data reference to plurality of nodes, preventing fraud through tampered blockchain from pretending true nodes, providing the rescue to reveal the discovery the error to provide effectively more secure wallet device 1.

In an embodiment illustrated as wallet device 1, there provided with own nodes in the wallet device 1. Alternately, transaction manager device 200 may further comprises a unit to create broadcast request data conformed to the broadcast server specification in bitcoin network transforming bitcoin transaction. The broadcast request data may be directly interfaced to the data in acceptor provided by a broadcast server in internet network. Alternatively, the wallet device 1 further comprises, a broadcast request server device including:
an output unit receiving the bitcoin transaction through the third communication network to create broadcast request data; and
an output unit transmitting the broadcast request data conformed to a specified data format in a broadcast server for bitcoin network in the internet network.

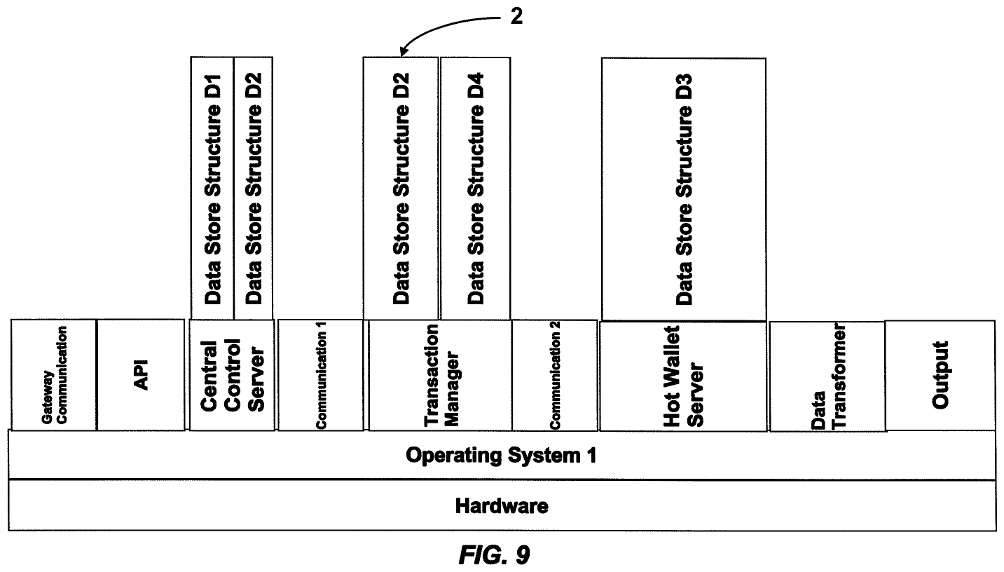

Further, FIG. 9 illustrates schematic configuration block diagram of another embodiment of the present invention for a wallet device 2. In the wallet device 2 of an embodiment of the present invention, all the modules illustrated in FIG. 2-FIG. 7 are operated in one operating system. The wallet device 2 has an advantage of minimum hardware source, nonetheless it is mandatory for the intruder to intrude multiple module boundary, improving more security.

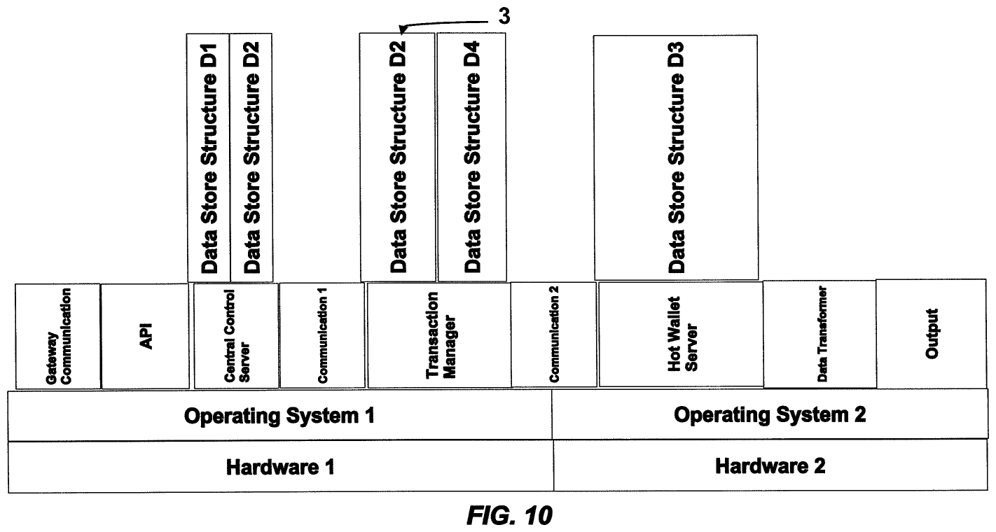

FIG. 10 illustrates schematic configuration block diagram of other embodiment of the present invention for a wallet device 3. In the wallet device 3 of an embodiment of the present invention, the hot wallet server module is operated in another operating system different from a first operating system for the central control module and transaction manager module, wherein the private keys are segregated by operating system boundary, therefore the access and use of the private keys are not quite easy from the central server module as well as from the transaction manager module. Therefore the wallet device 3 provides more secure wallet device.

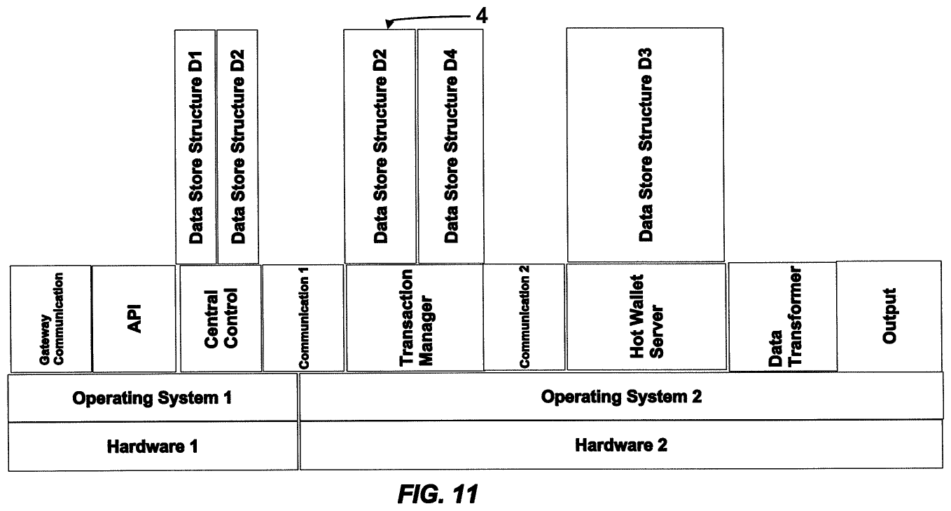

FIG. 11 illustrates schematic configuration block diagram of other embodiment of the present invention for a wallet device 4. In the wallet device 4 of an embodiment of the present invention, the hot wallet server module is operated in another operating system different from a first operating system for the central control module, wherein the private keys are segregated by operating system boundary, therefore the access and use of the private keys are not quite easy from the central server module. Therefore the wallet device 4 provides more secure wallet device.

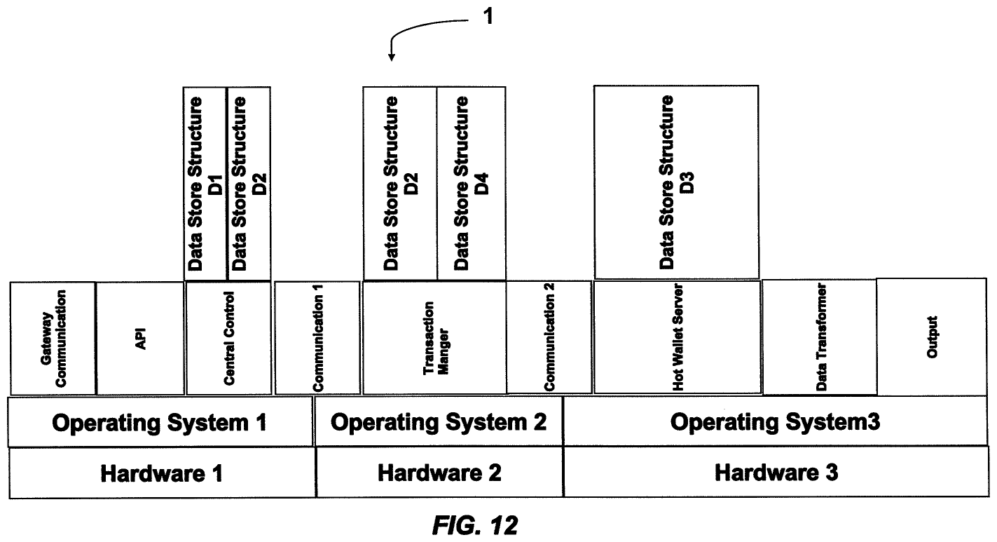

FIG. 12 illustrates schematic configuration block diagram of an embodiment of the present invention for a wallet device 1. In the wallet device 1 of an embodiment of the present invention, the hot wallet server module, transaction manager module and central control module are segregated each other, wherein the private keys are segregated by plurality of operating system boundaries from the central server module. Therefore the wallet device 1 provides further more secure wallet device.

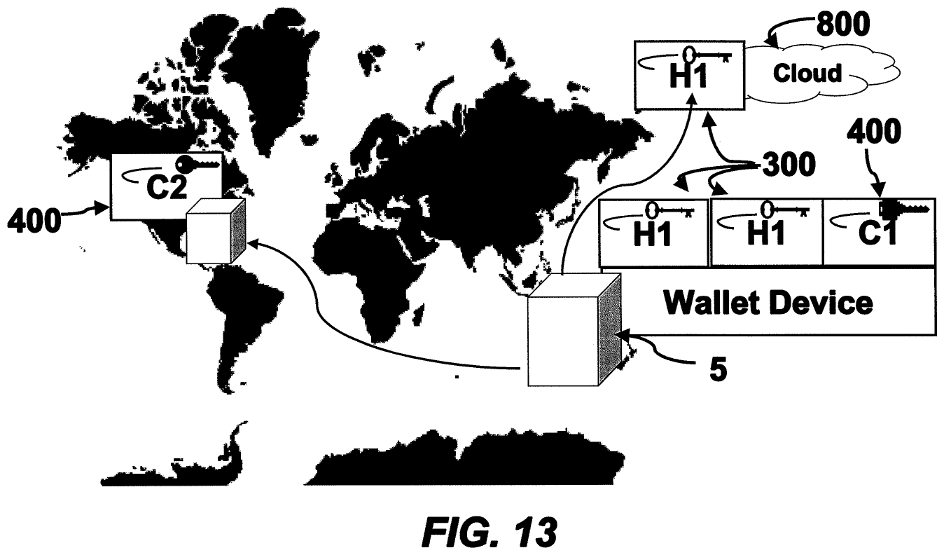

FIG. 13 illustrates other embodiment of the present invention, the transaction manager device connected plurality of hot wallet server device 300. The hot wallet server 300 are arranged in the same location. As such an embodiment, two of hot wallet server device provide the same signature service, having a same private key HOT1, the processing capacity of the wallet device approximately twice. The private key signature method described above, as the transaction manager system control flow can be performed in parallel, such a redundant configuration provides the scalability and the reduction of the waiting time window to receive a signature request provides to improve the higher processing speed and processing performance. In other words, transaction manager device 200 can request a signature request for an unsigned transaction corresponding to the private key HOT1 to any one of the hot wallet server device 300 in a group of two located in Asia and of one located in other site. As such, high scalability and high performance wallet device is provided. Here, another embodiment (not illustrated in FIG.) having another configuration comprising two of private keys, HOT1 and HOT2 for the hot wallet server device 300 may provide multi-signature configuration. Here an intruder is force to attack multiple hot wallet server device located in multiple sites, therefore more secure wallet device is provided in the embodiment.

The embodiment of the present invention illustrated in FIG. 13, a wallet device comprises at least one of the hot wallet server device arranged in remote, providing more secure for local disasters.

The embodiment of the present invention illustrated in FIG. 13, a wallet device comprises plurality of the cold wallet server device 400, wherein one of which arranged in remote in the United States, providing an advantage to manage the private key in international location, providing more secure environment for human resource develop management, against intrude from international and nationwide disasters.

In an embodiment illustrated in FIG. 13, one of the hot wallet server device 300 is, for examples, configured in a virtual server on the cloud computing server, acquiring the diversity of the sever allocation, providing the hot wallet server device 300 in remote recovery site alternation. The cloud computing server may be available over one or plurality of cloud computing service providers, providing diversity options and attaining distributed computing. The multi-signature may be configured over the cloud computing service providers, reducing the risk of internal malice jobs and improving both the security in availability and disaster recovery.

Embodiments of the present invention of wallet device illustrated in FIG. 1-13, bitcoin is illustrated for the use of one of cryptocurrency embodiment, whereas the essence of technical idea presented herein for cryptocurrency using blockchain technology can be applied for as well as bitcoin, so as to attain the same effect.

Further in detail, so called alto coin such as Bitcoin Cash, Bitcoin Gold, Litecoin, Monacoin, Dogecoin and the like, are derived from revised attribute and/or attribute addition of bitcoin under the blockchain technology, therefore those skilled in art can apply any means of the essence of technical idea disclosed herein to alto coin, so as to attain the same effect.

The present specification described the embodiments of the present invention, however, the present invention is not limited to the embodiments presented herein, may be execute within the scope of the essence of the invention in various way. The present invention is described in the embodiments described further in detail, however the applicant has no intention to limit the scope of the claim by them additional advantage or revision may be understand by those of skilled in the art, an elements described in an embodiment may be adopted to other embodiments. Therefore, the invention is not limited by specific matter in broad aspect disclosing the devices and the examples. Therefore without departing from the sprit and scope of the general concept of the invention of the applicant, the invention may apart from the matter described in detail herein.

### INDUSTRIAL APPLICABILITY OF THE INVENTION

The present invention is applicable to a wallet device for cryptocurrency based on public key cryptography, using a private key to create a public key, used widely, for examples, for a cryptocurrency exchange, cryptocurrency trader, internet transaction settlement business.

### DESCRIPTION OF THE REFERENCE NUMERALS

1 an embodiment of a wallet device
2 another embodiment of a wallet device
3 other alternative embodiment of a wallet device
4 other alternative embodiment of a wallet device
5 other alternative embodiment of a wallet device
100 central control device
110 API module
120 central control module (central control unit)
200 transaction manager device
210 transaction manager module (transaction manager unit)
240 data transformer module (data transformer unit)
241 data output module (data output unit)
300 hot wallet server device
310 hot wallet server module (hot wallet server unit)
339 operation panel display
400 cold wallet server device
410 cols wallet server module (cold wallet server unit)
420 remote operation module (remote operation unit)
430 remote signature module (remote signature unit)
439 operation panel display
450 remote signature device
459 operation panel display
500 node manager device
510 node manager module (node manager unit)
600 node device
800 cloud computing service
D1 first data store structure (first data store structure data)
D2 second data store structure (second data store structure data)
D3 third data store structure (third data store structure data)
D4 fourth data store structure (fourth data store structure data)
C1 private key
C2 private key
H1 private key
M1 address master
M3 private key master

1. A wallet device for public key cryptography, the wallet device comprising:
a public key derived from a private key creating an address so as to be used in trading via a network;
a central control server device including:
a receiving unit configured to receive trading request data,
a memory configured to store a first data store structure that specifies the address to identify the public key for a signature,
an unsigned transaction creation unit having a second data store structure configured to hold the unsigned transaction, and
a communication unit, for a first communication network, configured to transmit the unsigned transaction;
a hot wallet server device including:
a memory configured to store a third data store structure data that stores and creates a private key,
a communication unit, for a second communication network, configured to receive a signature requester and send a signature, and
a cryptocurrency signature unit for the signature request;
a remote signature device that is offline from internet, the remote signature device including:
a memory that stores the third data store structure data that stores and creates the private key,
a cryptocurrency signature unit, and
a data propagation unit configured to input the signature request, and configured to be controlled by an operator to output the signature corresponding to the signature request accepted through the data propagation unit;
a cold wallet server device including:
a communication unit, for the second communication network, the communication unit being configured to transmit data in both directions and receive the signature requests from a signature requester, and configured to send the signature,
a memory configured to store a data store that stores an identification key as a mark for identifying the signature to be signed by the remote signature device, and
a data propagation unit configured to transfer data for signing remotely in combination with the remote signature device; and
a transaction manager device including:
a communication unit, for the first communication network, configured to receive the unsigned transaction from the central control server device,
a communication unit, for the second communication network, configured to send the signature request outbound and receive the signature from the hot wallet server device and/or the cold wallet server device,
a signature status management unit configured to hold the unsigned transaction until the signatures are completely signed,
a data transformer unit configured to transform the unsigned transaction to a cryptocurrency transaction to conform a cryptocurrency network,
a communication unit, for a third communication network, configured to output the cryptocurrency transaction, and
a memory configured to store a fourth data store structure data that specifies the public key corresponding to the third data store structure,
wherein the fourth data store structure is structured by the identification key to identify the signature associated as a mark.

2. The wallet device of claim 1, wherein each of the communication units for the first communication network is further configured to perform server authentication.

3. The wallet device of claim 1, wherein the transaction manager device is connected to a plurality of hot wallet server devices.

4. The wallet device of claim 1, wherein the cold wallet server device further includes:
a connection unit configured to connect to a portable data output unit as a data propagation unit, and
a connection unit configured to connect to an operation display panel unit, the operation display panel unit being configured to present an input prompt for outputting portable data for the signature request,
wherein operations by an operator enable to output the portable data for the signature request.

5. The wallet device of claim 4, wherein the remote signature device that is offline from internet further includes:
a connection unit configured to connect to the portable data read unit, and
a connection unit configured to connect to an operation display panel unit, the operation display panel unit being configured to present an input prompt for reading the portable data for the signature request,
wherein operations by an operator enables to read the portable data for the signature request.

6. The wallet device of claim 5, wherein the remote signature device that is offline from internet further includes:
a connection unit configured to connect to the portable data output unit, and
a connection unit configured to connect to an operation display panel unit, the operation display panel unit being configured to present an input prompt for outputting the portable data signed with the private key by cryptocurrency signature unit,
wherein the portable data output unit with the operator display panel equipped to output the portable data with the signed signature.

7. The wallet device of claim 6, wherein the cold wallet server device further includes:
a connection to the portable data read unit and an operation display panel unit, the operation display panel unit being configured to present an input prompt for reading the portable data with the signed signature,
wherein operations by an operator enables to read the portable data with the signed signature, and
wherein the portable data can be propagated from the cold wallet server device to the transaction manager device through the second communication network.

8. The wallet device of claim 4, wherein the portable data media is printed sheet with a QR code.

9. The wallet device of claim 1, wherein the transaction manager device is connected to a plurality of cold wallet server devices.

10. The wallet device of claim 3,
wherein the unsigned transaction is a multi-signature transaction to be signed by multiple private keys, and
wherein the private keys corresponding to the unsigned transaction are distributed to and stored in a plurality of hot wallet server devices.

11. The wallet device of claim 4,
wherein the unsigned transaction is a multi-signature transaction to be signed by multiple private keys, and
wherein the private keys corresponding to the unsigned transaction are distributed to and stored in a plurality of signature devices that are offline from internet.

12. The wallet device of claim 1,
wherein the unsigned transaction is a multi-signature transaction to be signed by multiple private keys, and
wherein the private keys corresponding to the unsigned transaction are distributed to and stored in one or more hot wallet server devices and one or more cryptocurrency signature devices that are offline from internet.

13. The wallet device of claim 1,
wherein the transaction manager device further includes an output unit so as to create broadcast request data by using the cryptocurrency transaction that transmits to a broadcast server through the cryptocurrency network.

14. The wallet device of claim 1, further comprising:
a broadcast request server device including:
a broadcast request creation unit configured to receive cryptocurrency transaction through the third communication network to create broadcast request data therefrom; and
an output unit configured to transmit the broadcast request data via the cryptocurrency network.

15. The wallet device of claim 1, further comprising:
one or more nodes, wherein a node of the one or more nodes includes a connection unit configured to connect to the cryptocurrency network via internet enabled to broadcast via the cryptocurrency network; and
a node manager device including:
a communication unit, for the third network, configured to receive the cryptocurrency transaction from the transaction manager device;
one or more connections with the one or more nodes; and
a broadcast unit configured to prepare broadcast data to transmit the cryptocurrency transaction via the node device.

16. The wallet device of claim 15, wherein the node manager device further includes:
a receive unit configured to receive a blockchain or unsigned transactions to be recorded in the blockchain; and
a compare unit configured to compare among the blockchain and/or the unsigned transactions to be recorded in the blockchain,
wherein a validation criteria in the compare unit for the blockchain and the unsigned transactions is whether matching party is majority or not.

17. The wallet device of claim 10, wherein at least one of the plurality of the hot wallet server devices is remotely located.

18. The wallet device of claim 11, wherein one or more cold wallet server devices are remotely located.

19. The wallet device of claim 1, further comprising:
an operation panel display unit configured to present an input prompt for requesting the signature to responsible operators to be signed to the unsigned transaction conformed to a specified condition,
wherein the operation panel display unit is connected to the hot wallet server device via an operation display server unit.

20. The wallet device of claim 19, wherein the operation panel display unit is configured to display the prompt for signing for the unsigned transaction of total amount of payment to be approved more than a specified threshold value.

21. The wallet device of claim 3, wherein the plurality of hot wallet server devices are configured to include:
a master data input unit configured to
input, from externally, at least part of data elements of the third data store structure to store and create a private key,
enable at least a part of data for storing and creating private keys in a partial group of the plurality of hot wallet server devices, and
wherein the transaction manager device having an output unit configured to enable propagation of the signature request to any hot wallet server devices in the group.

22. The wallet device of claim 1, wherein the first, the second and the third data store structure configured to store or create private keys of the wallet device, include:
a key sequence number to perform deterministic generation by the wallet device; and
a series of data sufficient to create and recreate the private key.

23. The wallet device of claim 22, wherein the first, the second and the forth data store structure and the data structure thereof further include a common key feature and common key data to create the signature request for the unsigned transaction, a master common key for the internal use in the cryptocurrency signature device to identify the sufficient private keys to sign the signature request for the unsigned transaction.

24. The wallet device of claim 23, wherein data including the common key and one or more seeds corresponding to the common key are aggregated as one group, and one or more set of the data group are stored for master data in the transaction manager device.

25. The wallet device of claim 14, wherein each of the devices is arranged in each virtual server device, respectively.

26. The wallet device of claim 3, wherein one or more parts of the hot wallet server device are arranged in a virtual server device provided in one or more cloud computing service server devices.

27. A method for signing a signature for the private key for a cryptocurrency signature wallet device of claim 24 equipped with an operating system to control a hardware having a CPU and a memory configured with a software installed in the operating system, including an address data configured,
the method comprising a first stage, the first stage including:
accepting data items, by an API (Application Program Interface), received from a user system through a gateway communication; and
creating, via the CPU, an unsigned transaction using the accepted data items in a software configured in an operating system on a central control server device,
wherein the cryptocurrency signature wallet device is configured as a deterministic wallet configured to perform trading, the method including preparing the addresses created by using the public key and private key,
wherein the unsigned transaction including a specified data store structure including:
one or more seed data fields having used in creating multi-signature addresses in creating the deterministic wallet;
a master common key field associated with the one or more seed data fields;
key sequence number data fields representing the sequence of the address creation; and
signature data fields configured to store the signatures,
wherein the central control server device having a communication unit, for a first network, configured to communicate with a transaction manager device,
wherein the first stage of the method further comprises transmitting the unsigned transaction from the central control server device to the transaction manager device through the communication unit, for the first communication network between the central control server device and the transaction manager device,
the method further comprising a sequenced second stage including:
upon receiving the unsigned transaction in the transaction manager device through the communication unit for the first communication network by a software installed in the operating system on the transaction manager device, storing the unsigned transaction in a transaction pool in the memory,
the method further comprising a sequenced third stage including:
causing the software in the operating system on the transaction manager device to enter a status of wait for notification from another device being ready for a signature request,
the method further comprising a fourth stage in parallel, the fourth stage including:
causing a software installed on an operating system on a hot wallet server device and a cold wallet server device to send, to the transaction manager device, a notification for signature request wait attached with the master common key through a communication unit for the second communication network,
the method further comprising a sequenced fifth stage including:
upon receiving the notification, causing a software installed on an operating system in the transaction manager device to search for unsigned transactions with the master common key matching in the transaction pool of unsigned transactions; and
sending one of the selected unsigned transaction for the signature request to the originator of the notification, the originator including hot wallet sever devices or cold wallet server devices, through the communication unit for the second network,
the method further comprising a sequenced sixth stage including:
causing a software installed on an operating system in the hot wallet server device to receive the signature request through a communication unit for the second communication network; and
causing the software installed on an operating system in a hot wallet server device to sign the signature request using the private key corresponding to the master common key; and
sending back the signature to the transaction manager device through the second communication network,
the method further comprising a seventh stage in parallel to the sixth stage, the seventh stage including:
upon receiving the signature request through a communication unit for the second communication network, causing a software installed on an operating system in a cold wallet server device to output portable data through a data propagation unit for a signature device to remotely sign the signature;
causing a software installed on an operating system in the signature device to read the portable data through a data propagation unit;
causing a software installed on an operating system in the signature device to sign a signature using the private key corresponding to the portable data to output a portable data through the data propagation unit; and
causing a software installed on an operating system in the cold wallet server device to transfer the signature through the second communication network,
the method further comprising a sequenced eighth stage including:
upon receiving the signature through the communication unit for the second communication network, causing a software installed on an operating system in the transaction manager device to write the signature in a signature field in the unsigned transaction;
summing up a number of signatures written in the signature fields to compare for validation to a specified criteria on sufficient number of multi-signatures to complete signing the unsigned transaction;
upon success in the validation, transforming the signed transaction into the cryptocurrency transaction; and
upon failure in the validation, causing the software on the operating system in the transaction manager device to return system flow control to the third stage to loop.

28. The method of claim 27, wherein the waiting further comprises a communication protocol that polls from the hot wallet server device or the cold wallet server device.

29. A wallet device for public key cryptography, the wallet device comprising an operating software installed on the operating system to control a hardware equipped with a CPU and a memory therein,
the software having configured a public key derived from a private key, and
the software having configured an address derived from the public key,
wherein the software comprising:
an API (Application Program Interface) input module configured to accept trading request data through the API;
a central control module configured to read first data store structure data that specifies the address to identify the public key for a signature, and configured to create an unsigned transaction having the second data store structure that holds the unsigned transaction;
a hot wallet module configured to sign a cryptocurrency signature having third data store structure data in memory to store the private key or to create the private key;
a cold wallet server module for offline signature having an identification key stored in memory to identify the signature associated as a mark;
a transaction manager module
configured to control a signing flow having been enabled to store the fourth data store structure including a third data store structure configured to hold or create the private key structured by a master common key shared among multiple modules to identify the private key, and
including the second data structure for holding the unsigned transaction;
an external communication module configured to communicate for external interface from API input module;
a first communication module configured to receive and transmit unsigned transactions and signed transactions between the transaction manager module and central control module;
a second communication module configured to receive and transmit unsigned transactions and signed transactions between the transaction manager module and the hot wallet module or between the transaction manager module and the cold wallet server module;
a data propagation module configured to receive portable signature request data, and transmit portable signature data from and to the signature device for offline signatures;
data transform module configured to transform the signed transaction into the cryptocurrency transaction; and
output module configured to create and output broadcast request data for the cryptocurrency by accepting all the signature completed by the transaction manager module,
wherein the wallet device further comprises:
a cryptocurrency signature device further equipped with:
the third data store structure configured to store the private key or to create the private key;
the data propagation unit; and
a cryptocurrency signature unit configured to input the signature request through the data propagation unit.

30. The wallet device of claim 29, wherein the central control server module and the transaction manager module are operated on the same operating system.

31. The wallet device of claim 29, wherein one or more hot wallet modules are operated on the same operating system as the transaction manager module.

32. The wallet device of claim 29, wherein the hot wallet module is operated on another one or more operating systems different from the operating system operating on the transaction manager module.

33. The wallet device of claim 1, wherein the cryptocurrency is a virtual currency.

34. The wallet device of claim 1, wherein the cryptocurrency is a bitcoin.

35. The method of claim 27, wherein the cryptocurrency is a virtual currency.

36. The method of claim 27, wherein the cryptocurrency is a bitcoin.

37. The wallet device of claim 1, wherein the cryptocurrency is a meta coin or an alt coin, the meta coin or the alt coin including partially adding attributes and/or modifying attributes to bitcoin.

38. The method of claim 27, wherein the cryptocurrency is a meta coin or an alt coin, the meta coin or the alt coin including partially adding attributes and/or modifying attributes to bitcoin.

39. The wallet device of claim 1, wherein the trading request data defined through an Application Program Interface (API) with a requester server program, including:
1) a master common key to specify one or more payers;
2) one or more destination addresses;
3) a payment amount;
4) a transaction fee cover code to determine whether the transaction processing fee for cryptocurrency network is to be paid by the address identified by the address specifying payer cryptocurrency account in transaction input or a payer address derived from the master common key or the destination address.

40. The wallet device of claim 1, wherein the first data store structure and the structure data thereof are configured to specify the address to identify the public key for a signature comprising data items including:
1) a master common key field configured to store the master common key corresponding to the address;
2) key sequence number data fields representing the sequence of the address creation; and
3) the address in the cryptocurrency network.

41. The wallet device of claim 1, wherein the second data store structure and the structure data thereof to hold the unsigned transaction, for the use of transaction input data items, including one or more pairs of data items 1) and 2) listed below, conformed to a bitcoin standard transaction in a bitcoin architecture to identify a Unspent Transaction output (UTXO) and then identify a previous transaction, the second data store structure including:
1) prev hash; and
2) prev hash output index,
wherein the second data store structure further includes one or more pairs of data items 3) and 4) listed below, conformed to the bitcoin standard transaction output data items in the bitcoin architecture, the second data store structure further including:
3) a destination address; and
4) an amount of the cryptocurrency,
wherein the second data store structure further includes extended-transaction (eTX) input data items per transaction input, the second data store structure further including:
5) a master common key field configured to store the master common key to identify the public key corresponding to the first data store structure data; and
6) key sequence number data used in a deterministic wallet creation,
wherein the extended-transaction data fields within the second data store structure further includes:
7) signature fields configured to store the signatures,
wherein the extended-transaction data within the second data store structure further includes:
8) a transaction status code data field configured to store an identifier of a waiting status for the signature or a validated signed status, or a transmitted status, respectively.

42. The wallet device of claim 1, wherein the third data store structure and the structure data thereof are configured to store the private key or to create the private key comprising data items including:
1) the private key seed field used in the deterministic wallet creation; and
2) the key sequence number data fields used in the deterministic wallet creation.

43. The wallet device of claim 1, wherein the fourth data store structure and the structure data thereof are configured to specify the private key comprising data items:
1) the master common key fields configured to identify the private key in the third data store structure data, and
wherein each master common key holds:
2) one or more seed fields for the public key used in creating the deterministic wallet, corresponding to one or plurality of the multi-signature; and
3) key sequence number data used in a deterministic wallet creation.
